(19) United States
(12) Patent Application Publication
(10) Pub. No.: US 2014/0081632 A1
(43) Pub. Date: Mar. 20, 2014

(54) COMPUTER PRODUCT, ANALYSIS SUPPORT APPARATUS, AND ANALYSIS SUPPORT METHOD

(71) Applicant: FUJITSU LIMITED, Kawasaki-shi (JP)

(72) Inventor: Takayuki SASAKI, Kawasaki (JP)

(73) Assignee: FUJITSU LIMITED, Kawasaki-shi (JP)

(21) Appl. No.: 13/955,081

(22) Filed: Jul. 31, 2013

(30) Foreign Application Priority Data
Sep. 18, 2012 (JP) 2012-205115

(51) Int. Cl. G10L 15/08

(52) U.S. Cl. CPC G10L 15/08
USPC 704/231

(57) ABSTRACT

A computer-readable recording medium stores a program causing a computer to execute a process that includes acquiring first scenario information that formalizes and indicates a character set of characters appearing in a first scene, a knowledge set of knowledge items retained by the characters, and an action set of actions taken by the characters; receiving into the action set, an input of speech contents of a speech action from a first character to a second character who appear in the first scene; producing second scenario information that inherits the character set and the knowledge set of the first scenario information and, formalizes and indicates for a second scene, a character set, a knowledge set, and an action set; and registering into the knowledge set of the second character indicated in the second scenario information, the speech contents of the speech action for which the input is received.

### CROSS REFERENCE TO RELATED APPLICATIONS

This application is based upon and claims the benefit of priority of the prior Japanese Patent Application No. 2012-205115, filed on Sep. 18, 2012, the entire contents of which are incorporated herein by reference.

### FIELD

The embodiments discussed herein are related to a computer product, analysis support apparatus, and analysis support method.

### BACKGROUND

In software engineering, requirements analysis is a process that concerns a survey for or a definition of a new system or system updating. The requirements analysis includes, for example, steps of drawing out requirements from a customer through dialogue; clearing up the discrepancies and problems by clarifying requirements; and putting the requirements in writing. In the requirements analysis, an extraction of problems via role playing may be executed.

Conventional technology includes, for example, a technique to model a discrete event system utilizing an event flowchart; a technique of visualization using a model the relations among the elements of a knowledge and information processing system based on an object-oriented paradigm; a technique to produce an action on a subject system; and a technique to produce a finite state machine model.

For examples, refer to Published Japanese-Translation of PCT Application, Publication No. 2004-502234, Japanese Laid-Open Patent Publication No. 2003-076548, and Published Japanese-Translation of PCT Application, Publication Nos. 2008-517362 and 2009-501970.

Nonetheless, according to the conventional techniques, a significant amount time and labor are necessary to clarify the information exchanged for the requirements analysis. Consequently, a problem arises in that the work load for the analysis increases. For example, a significant amount of time and effort are necessary for a person in charge of the requirements analysis to stay on top of circumstances that continuously change consequent to communication among the individuals involved and to clarify the information exchanged.

### SUMMARY

According to an aspect of an embodiment, a computer-readable recording medium stores an analysis support program causing a computer to execute a process. The process includes acquiring first scenario information that formalizes and indicates a character set of characters appearing in a first scene, a knowledge set of knowledge items retained by the characters appearing in the first scene, and an action set of actions taken by the characters appearing in the first scene; receiving into the action set indicated in the first scenario information, an input of speech contents of a speech action from a first character to a second character who appear in the first scene; producing second scenario information that inherits the character set and the knowledge set indicated in the first scenario information and, formalizes and indicates a character set of characters appearing in a second scene, a knowledge set of knowledge items retained by the characters appearing in the second scene, and an action set of actions taken by the characters appearing in the second scene; and registering into the knowledge set of the second character indicated in the produced second scenario information, the speech contents of the speech action for which the input is received.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of an analysis support method according to an embodiment;

FIG. 2 is a block diagram of a hardware configuration of an analysis support apparatus 101 according to the embodiment;

FIG. 3 is a block diagram of an example of a functional configuration of the analysis support apparatus 101;

FIG. 4 is an explanatory diagram of a class diagram of a partial order set;

FIG. 5 is an explanatory diagram of an object diagram of the partial order set;

FIG. 6 is an explanatory diagram of a comics chart situation theory;

FIG. 7 is an explanatory diagram of the inclusion relation of concepts by UML notation;

FIG. 8 is an explanatory diagram of classification of Infon based on the nature thereof;

FIG. 9 is an explanatory diagram of an example of an interpretation of a general Infon;

FIG. 10 is an explanatory diagram of an example of an interpretation of a factual Infon;

FIG. 11 is an explanatory diagram of an example of Infon that has a complicated meaning;

FIG. 12 is an explanatory diagram of a definition of a concept in a partial order set;

FIG. 13 is an explanatory diagram of a definition of a top member and of a bottom member;

FIG. 14 is an explanatory diagram of a definition of a function of acquiring the partial order set of the relation natures;

FIG. 15 is an explanatory diagram of an example of an abridgement algorithm;

FIG. 16 is an explanatory diagram of an example of a result of application of the abridgement algorithm;

FIGS. 17, 18, 19, 20, 21, 22, 23, 24, and 25 are explanatory diagrams of examples of scenes;

FIG. 26 is an explanatory diagram of an example of an unknown Infon;

FIG. 27 is an explanatory diagram of a specific example of a classification table 2700;

FIGS. 28A and 28B are explanatory diagrams of an example of a comics chart taking an example of academic research;

FIG. 29 is an explanatory diagram of a definition of parallel establishment;

FIGS. 30, 31, 32, 33, 34, 35, 36, 37, and 38 are explanatory diagrams of an example of a comics chart that includes “YES-or-NO Query”;

FIGS. 39 and 40 are explanatory diagrams of an example of a “What” query; and

FIG. 41 is a flowchart of an example of an analysis support process procedure of the analysis support apparatus 101.

### DESCRIPTION OF EMBODIMENTS

Embodiments of an analysis support program, an analysis support apparatus, and an analysis support method will be described in detail with reference to the accompanying drawings.

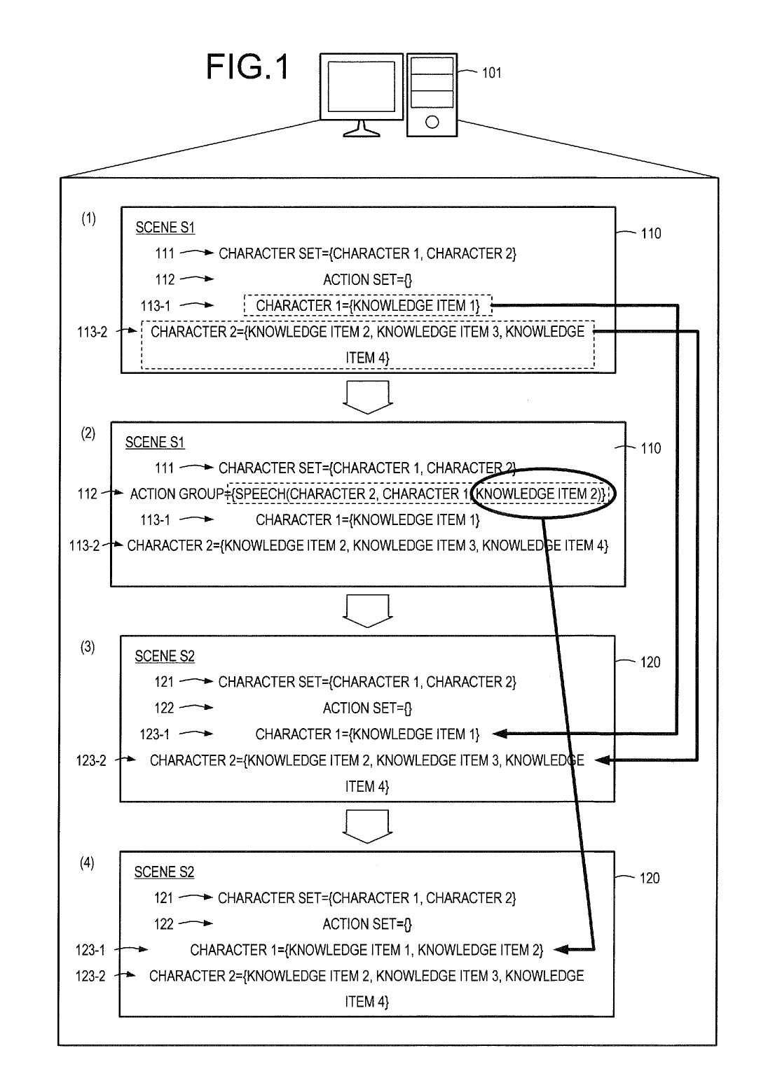

FIG. 1 is an explanatory diagram of an example of an analysis support method according to an embodiment. In FIG. 1, the analysis support apparatus 101 is a computer that supports analysis of an event. The event to be analyzed is, for example, an event whose situation (scene) changes consequent to communication among individuals involved, the communication being analyzed by role playing.

The analysis support method is applicable to, for example, requirements analysis in software engineering, analysis of the cause of an accident, and evaluation of a business model or a customer service manual. Description herein will be made taking an example of requirements analysis in software engineering.

In executing the requirements analysis, a significant amount of time and effort are necessary for a person in charge of the requirements analysis to stay on top of scenes that continuously change consequent to communication among the individuals involved and to systematize and manually clarify the information exchanged. It is difficult to determine what manner of clarifying the information exchanged among the individuals involved enables extraction of useful information.

In the embodiment, when a character in a scene speaks, the analysis support apparatus 101 produces scenario information for the next scene. The scenario information enables of the scenario information for the next scene to inherit the characters in the current scene as well as the knowledge of the characters, and adds the information conveyed by a speaker to the knowledge of a listener, whereby comprehension of the situation that continuously changes due to communication among the individuals involved is facilitated, and the work load for the requirements analysis can be reduced.

(1) The analysis support apparatus 101 acquires the scenario information for a first scene. A scene represents a portion of the changing situation and is characterized by, for example, the characters therein, knowledge retained by the characters, and actions of the characters. The scenario information is information that formalizes and indicates a character set of the characters who appear in the scene, a knowledge set of the knowledge retained by the characters, and an action set of the actions taken by the characters.

The “knowledge of the characters” is information indicating a matter known by the characters. The knowledge of the characters is expressed as, for example, information that indicates a relation between an indeclinable word and a declinable word. An “indeclinable word” is a word that can alone act as a subject and is, for example, a noun. A “declinable word” is a word that can alone act as a predicate and is, for example, a verb. An example of the knowledge can be, for example, knowledge that “A bird (indeclinable word) flies (declinable word)”. An “action taken by a character” is information indicating an event that occurs in a scene. An example of an action can be, for example, the speech, entry, or exit of a character.

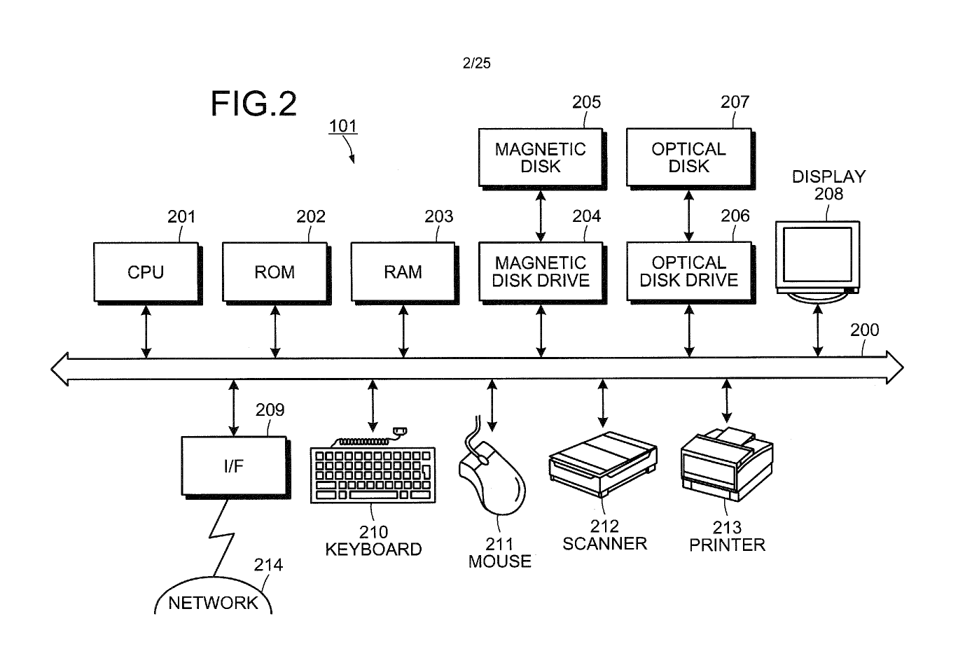

For example, the analysis support apparatus 101 may acquire the scenario information for a first scene by producing the scenario information for the first scene by duplicating the scene immediately preceding the first scene (for example, an initial scene). The scenario information for the scene immediately preceding the first scene (for example, the initial scene) is stored in, for example, a memory, etc., (for example, a RAM 203, a magnetic disk 205, or an optical disk 207 described later with reference to FIG. 2). The analysis support apparatus 101 may acquire first scene scenario information that is directly input into the analysis support apparatus 101 by a user (for example, the person in charge of the requirements analysis).

In the example of FIG. 1, scenario information 110 for a scene S1 is acquired. The scenario information 110 includes a character set 111 of the characters who appear in the scene S1, an action set 112 of the actions taken by the characters, a knowledge set 113-1 of knowledge retained by a character 1, and a knowledge set 113-2 of knowledge retained by a character 2. The character set 111 includes the characters 1 and 2. The action set 112 is an empty set. The knowledge set 113-1 includes a knowledge item 1 retained by the character 1. The knowledge set 113-2 includes knowledge items 2, 3, and 4 retained by the character 2.

(2) The analysis support apparatus 101 receives an input of the speech contents of a speech action performed by a first character with respect to a second character who both appear in the first scene, for input into the action set indicated in the scenario information for the first scene. The input speech contents of the speech action is knowledge retained by the first character.

For example, analysis of how the scene changes consequent to the first character telling the second character the knowledge retained by the first character may be desired. In this case, the person in charge of the requirements analysis inputs into the action set indicated in the scenario information, for example, the speech contents (the knowledge retained by the first character) of the speech action performed by the first character with respect to the second character.

In the example of FIG. 1, “speech (the character 2, the character 1, the knowledge item 2)” is input into the action set 112 indicated in the scenario information 110. “Speech (the character 2, the character 1, the knowledge item 2)” represents that the character 2 speaks the knowledge item 2 retained by the character 2, to the character 1.

When the analysis support apparatus 101 receives the input of the speech contents of the speech action, into the action set 112, the analysis support apparatus 101 may output the scenario information 110 that has “speech (the character 2, the character 1, the knowledge item 2)” input into to the action set 112 thereof. Thereby, the analysis support apparatus 101 can output the scenario information 110 of the scene S1 in which the character 2 speaks about the “knowledge item 2” to the character 1.

(3) The analysis support apparatus 101 produces scenario information for a second scene. The second scene scenario information inherits the character set and the knowledge sets indicated in the scenario information for the first scene. For example, the analysis support apparatus 101 produces scenario information 120 that includes a character set 121 and knowledge sets 123-1 and 123-2 that are formed by duplicating the character set 111 and the knowledge sets 113-1 and 113-2 of the scenario information 110. In this production, the analysis support apparatus 101 sets an action set 122 of the scenario information 120 to be an empty set.

(4) The analysis support apparatus 101 registers into the knowledge set of the second character indicated in the produced scenario information for the second scene, the speech contents of the input speech action. For example, the analysis support apparatus 101 registers into the knowledge set 123-1 of the scenario information 120, the “knowledge item 2” of the “speech (the character 2, the character 1, the knowledge item 2)” that is input into the action set 112 of the scenario information 110. Thereby, the analysis support apparatus 101 can add the “knowledge item 2” that is spoken by the character 2 to the character 1, as knowledge retained by the character 1.

After the registration, the analysis support apparatus 101 may output the scenario information 120 whose knowledge set 123-1 has the “knowledge item 2” registered therein. Thus, the analysis support apparatus 101 can output the scenario information 120 of the scene S2, reflecting that the knowledge retained by the character 1 changed due to the speech made by the character 2 about the “knowledge item 2”.

As described, according to the analysis support apparatus 101, an input of the speech contents of a speech action performed by the first character with respect to the second character can be received for input into the action set indicated in the scenario information for the scene. According to the analysis support apparatus 101, when the speech contents of the speech action is input into the action set, the scenario information for the next scene can be produced inheriting the character set and the knowledge sets indicated in the scenario information for the previous scene. According to the analysis support apparatus 101, the speech contents of the speech action whose input is received can be registered into the knowledge set of the second character indicated in the scenario information for the next scene.

Thus, the scenario information for the next scene can be produced in response to the speech action that is input by the user; and scenario information can be provided that facilitates comprehension of scenes, which continuously change due to communication among the individuals involved. As a result, the information exchanged among the individuals involved can be systematized and clarified, and the efficiency of the work necessary for the requirements analysis can be improved.

FIG. 2 is a block diagram of a hardware configuration of an analysis support apparatus 101 according to the embodiment. As depicted in FIG. 2, the analysis support apparatus 101 includes a central processing unit (CPU) 201, a read-only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213, respectively connected by a bus 200.

The CPU 201 governs overall control of the analysis support apparatus 101. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The optical disk drive 206, under the control of the CPU 201, controls the reading and writing of data with respect to the optical disk 207. The optical disk 207 stores therein data written under control of the optical disk drive 206, the data being read by a computer.

The display 208 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 200.

The I/F 209 is connected to a network 214 such as a local area network (LAN), a wide area network (WAN), and the Internet through a communication line and is connected to other apparatuses through the network 214. The I/F 209 administers an internal interface with the network 214 and controls the input/output of data from/to external apparatuses. For example, a modem or a LAN adaptor may be employed as the I/F 209.

The keyboard 210 includes, for example, keys for inputting letters, numerals, and various instructions and performs the input of data. Alternatively, a touch-panel-type input pad or numeric keypad, etc. may be adopted. The mouse 211 is used to move the cursor, select a region, or move and change the size of windows. A track ball or a joy stick may be adopted provided each respectively has a function similar to a pointing device.

The scanner 212 optically reads an image and takes in the image data into the analysis support apparatus 101. The scanner 212 may have an optical character reader (OCR) function as well. The printer 213 prints image data and text data. The printer 213 may be, for example, a laser printer or an ink jet printer.

The analysis support apparatus 101 may omit, for example, the optical disk drive 206, the optical disk 207, the scanner 212, and the printer 213 among the above components.

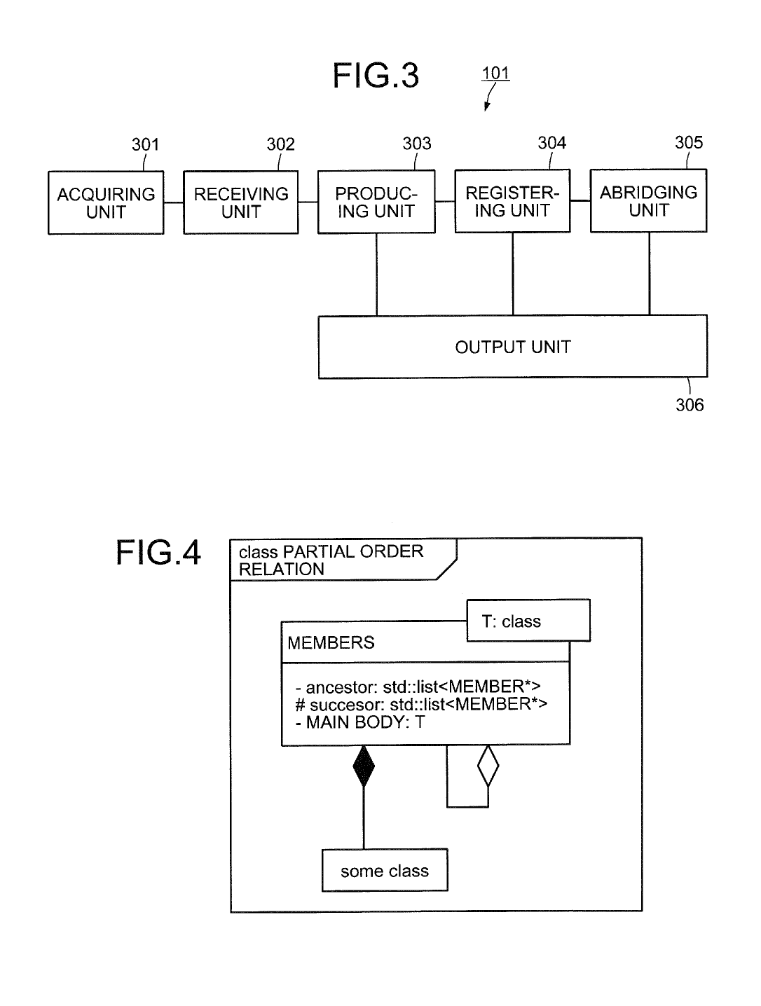

FIG. 3 is a block diagram of an example of a functional configuration of the analysis support apparatus 101. In FIG. 3, the analysis support apparatus 101 includes an acquiring unit 301, a receiving unit 302, a producing unit 303, a registering unit 304, an abridging unit 305, and an output unit 306. The units from the acquiring unit 301 to the output unit 306 are functions forming a control unit and are implemented, for example, by causing the CPU 201 to execute programs stored in a storage device such as the ROM 202, the RAM 203, the magnetic disk 205, or the optical disk 207 depicted in FIG. 2, or via the I/F 209.

The acquiring unit 301 has a function of acquiring the scenario information of a scene. For example, the acquiring unit 301 may acquire the scenario information for a current scene by reading the scenario information for the current scene from a storage device such as the RAM 203. The “current scene” refers to a scene to be processed.

In the initial state where no new scene is produced, the current scene is the initial scene. The initial scene expresses therein, for example, a character who appears from the start of the scene and knowledge that the character knows from the start of the scene. The scenario information for the initial scene is produced according to input by the user via the keyboard 210 or the mouse 211 depicted in FIG. 2, and is stored in a storage device such as the RAM 203.

For example, when the acquiring unit 301 receives an acquisition request for the current scene via user input, the acquiring unit 301 may acquire the scenario information for the current scene. The analysis support apparatus 101 may display on the display 208 (see FIG. 2), the scenario information for the current scene that is acquired by the acquiring unit 301. Thereby, the person in charge of the requirements analysis can edit the current scene scenario information displayed on the display 208.

Scenario information for each scene is correlated with a scene ID of the scene and stored in a storage device such as the RAM 203, for example. A “scene ID” is identification information identifying a scene. The user can designate an arbitrary scene as the current scene by designating the scene ID of the arbitrary scene.

The receiving unit 302 has a function of receiving input of the speech contents of a speech action performed by the first character with respect to the second character who both appear in the current scene, into the action set indicated in the scenario information for the current scene. For example, the receiving unit 302 receives, via user input, an input of the speech contents of the speech action performed by the first character with respect to the second character. The “speech action” corresponds to a “say action” described later and is described as, for example, “say (speaker, listener, speech contents)” in a predicate form using three arguments.

The producing unit 303 has a function of producing scenario information for the next scene such that the scenario information inherits the character set and the knowledge sets indicated in the scenario information for the current scene. For example, the producing unit 303 produces the scenario information for the next scene by duplicating the character set and the knowledge sets of the scenario information for the current scene. In this case, the producing unit 303 sets the action set of the scenario information for the next scene to be an empty set.

For example, the producing unit 303 may produce the scenario information for the next scene when a switching instruction for switching from the current scene to the next scene is received consequent to the producing unit 303 receiving the input of the speech contents of the speech action via user input.

The registering unit 304 has a function of registering into the knowledge set of the second character indicated in the produced scenario information for the next scene, the speech contents of the speech action that is input into the action set of the scenario information for the current scene. Thereby, the registering unit 304 can add the knowledge spoken by the first character to the second character, as knowledge retained by the second character.

The registering unit 304 may determine whether the speech contents of the speech action is included in the knowledge set of the second character indicated in the scenario information for the next scene. If the registering unit 304 determines that the speech contents of the speech action is not included in the knowledge set of the second character, the registering unit 304 may register the speech contents of the speech action into the knowledge set of the second character. On the other hand, if the registering unit 304 determines that the speech contents of the speech action is included in the knowledge set of the second character, the registering unit 304 may omit registration of the speech contents into the knowledge set of the second character. Thereby, the registering unit 304 can add the new knowledge for the second character that is spoken by the first character to the second character as the knowledge retained by the second character.

The registering unit 304 registers the sequential relation of the current scene and the next scene into a partial order set of the scenes. The “partial order set of the scenes” refers to information that indicates the sequential relation of the scenes. The partial order set of the scenes has, for example, at least the scene ID of the initial scene or the scene ID of the first scene produced based on the initial scene registered therein. The partial order set of the scenes corresponds to “script” described later.

For example, the registering unit 304 reads the partial order set of the scenes from a storage device such as the RAM 203 and registers the scene ID of the next scene after the scene ID of the current scene in the partial order set of the scenes. According to the partial order set of the scenes, the transition of the scenes, which continuously change due to communication among the individuals involved, can be identified.

The abridging unit 305 has a function of executing logic abridgement of the knowledge set of the second character of the scenario information for the next scene when the speech contents of the speech action is registered into the knowledge set of the second character. “Logic abridgement” refers to removal of the knowledge implied by other knowledge items of a knowledge group included in the knowledge set, i.e., deletion of the knowledge items from the knowledge set.

The “knowledge” is expressed as information that indicates the relation between an indeclinable word (a word like a noun) and a declinable word (a word like a verb) as described above. Therefore, the abridging unit 305 may execute the logic abridgement of the knowledge set of the second character based on, for example, a partial order set of the indeclinable words, or may execute the logic abridgement of the knowledge set of the second character based on the partial order set of the indeclinable words and the partial order set of the declinable words.

The partial order set of the indeclinable words and the partial order set of the declinable words are produced in advance and are stored in a storage device such as the RAM 203. Detailed description of the logic abridgement will be described later. The indeclinable word corresponds to, for example, “concept” described later and the declinable word corresponds to, for example, “relation” described later.

The output unit 306 has a function of outputting the scenario information for the next scene. For example, the output unit 306 may output the scenario information for the next scene as a result of the registration of the speech contents of the speech action, into the knowledge set of the second character in the scenario information for the next scene. The output unit 306 may output the scenario information for the next scene as a result of the execution of the logic abridgement for the knowledge set of the second character of the scenario information for the next scene.

The output unit 306 may output the partial order set of the scenes. The output form of the output unit 306 can be, for example, storage in a storage device such as the RAM 203, display on the display 208, output to and printing by the printer 213, and transmission to an external computer by the I/F 209.

The receiving unit 302 may receive an input of an entry action for the entrance of a new character who is different from the characters appearing in the current scene, for input into the action set indicated in the scenario information for the current scene. For example, the receiving unit 302 receives the input of the entry action for the new character to enter, via user input.

In this case, the registering unit 304 may register into the character set indicated in the produced scenario information for the next scene, the new character who enters according to the input entry action. Thereby, the registering unit 304 can add, as a character in the next scene, the new character who enters via the entry action.

The receiving unit 302 may also receive an input of an exit action for a third character who appears in the current scene to exit, for input into the action set indicated in the scenario information for the current scene. For example, the receiving unit 302 receives the input of the exit action for the third character to exit, via user input.

In this case, the registering unit 304 may delete from the character set indicated in the produced scenario information for the next scene, the third character who exits via the input exit action, and may further delete the knowledge set of the third character indicated in the scenario information for the next scene. Thereby, the registering unit 304 can delete from among the characters on the next screen, the third character who exits via the exit action.

Formalization of “information” according to the embodiment will be described. In the requirements analysis, it is important to clarify the assumed situation; and it is also important to clarify the information and events that cause the assumed situation to change. “Situation semantic theory” and “contextual theory” are theories that formalize a natural language using situations and information.

Comics is a medium that clarifies the transition of situations. Each frame is a medium depicting information as a picture and describing information as text. Comics can be said to be a form of expression that enables the provider of the medium and the readers thereof to share the transition of the situation based on straightforward data provided for each frame and to further be a form of expression by which no misunderstanding tends to occur.

In the embodiment, a case will be described where the form of expression of a requirement is formalized using “requirements analysis”, “situation semantic theory and contextual theory”, and “comics” as keywords.

(Definition Based on Situation Semantic Theory and Contextual Theory)

In the embodiment, the analysis support apparatus 101 formalizes “information” using tuple notation as follows. In the embodiment, the formalized information may be written as “Infon”.

Infon:<R,O₁, . . . ,Oₙ,P>

### R: Relation

### O₁: Object

P: Polarity{true, false}

### Meaning:

if P==true then a relation R is established among objects O₁ to Oₙ else the relation R is not established among the objects O₁ to Oₙ

Establishment of Infon iⱼ in a situation “sₖ” is expressed as Eq. (1) below. Thereby, syntax is defined that represents a relation between the situation and the information.

sₖ [symbol] iⱼ (1)

It is assumed that the situation is characterized by the information set that is established in the situation and the situation is defined as expressed in Eqs. (2) and (3) based on the set theory (the situation definition based on the set theory).

sₖ={i₁, . . . ,iₙ} (2)

sₖ [symbol] iⱼ [symbol] iⱼεsₖ (3)

As described, the execution of the formalization of the information based on the set theory and algebra enables an effect to be achieve that is identical to that in a case where the software configuration is defined. For example, when a partial order set is present, a set of members constituting a relation and the definition of the partial order among the members only have to be present for the partial order set. Considering this for software, it can be interpreted that the software defines the relation among the members though the details of the members are abstracted like a standard template library (STL).

A “member” can be regarded as an instance of a template, and “partial order a<b” can be regarded as a link from the instance “a” of the template to “b”, that is, this means that only a pointer to b has to be present in a succeeding member list that is defined in the instance “a”. For example, as depicted in FIG. 4 described later, the partial order set can be defined by causing the pointer list to the succeeding member and a pointer to a parent to be retained therein. As described above, a discrete algebra structure can be regarded to define the software structure.

FIG. 4 is an explanatory diagram of a class diagram of a partial order set. FIG. 4 depicts an example of a class of the partial order set. “Some class” in FIG. 4 represents a class that is designated by a template. A concept of “in contact” is defined. A detailed description of the concept of “in contact” will be made later with reference to FIG. 12.

An “ancestor” of a member “α” is a list of a member “P” that is in contact with the member α and that is β→α. A “successor” of a member α is a list of the element β that is in contact with α and that is α→β. Thereby, the partial order set can be implemented.

An example of the partial order set of scenes can be, for example, as follows, where, “S” denotes a scene (scenario), “T” denotes the start, and “⊥” denotes the end.

T→S1→S2→S3→⊥

S2→S4→S6→⊥

S2→S5→S6

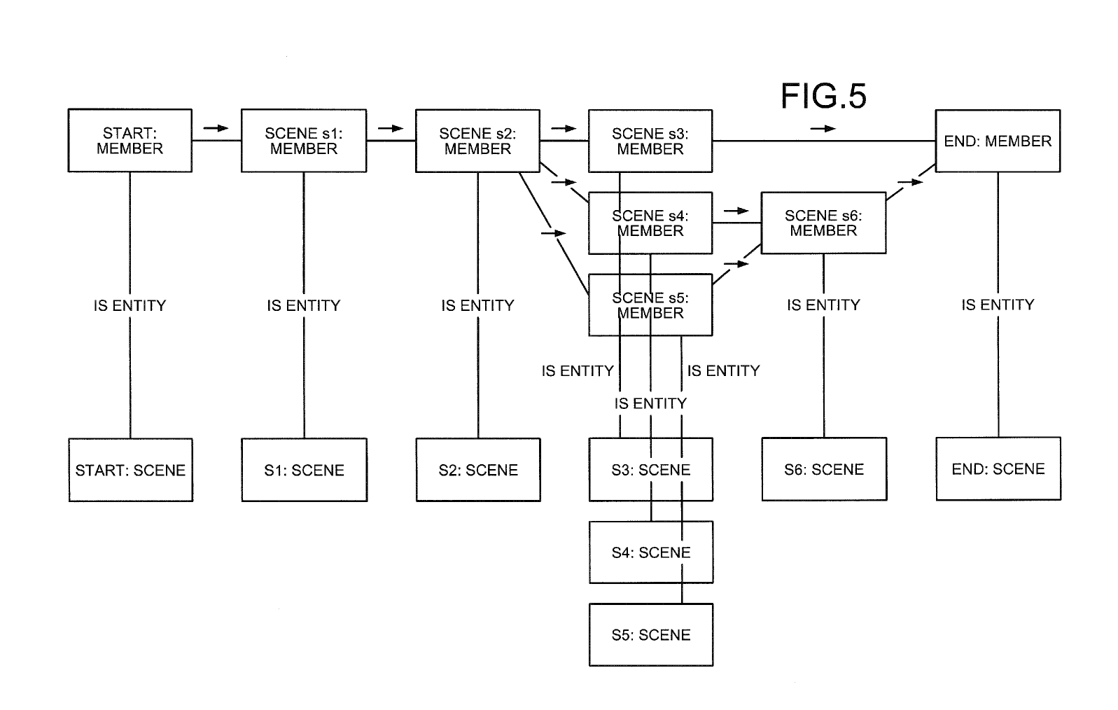

FIG. 5 is an explanatory diagram of an object diagram of the partial order set. FIG. 5 depicts an object diagram having the example of the partial order set of the scenes represented by a class (see FIG. 4). As above, only such containers can be implemented in the software as containers prepared by the STL or a Scala language (a set, a list, etc.) and a container that is a partial order set.

In a case where a user tries to comprehend well what problem arises due to speech in a given scene under the requirements analysis, it is difficult to acquire an intuitive understanding in which no misunderstanding occurs if it is not clear “who knows what information”.

For example, when a customer comes to a service counter and asks a question, the customer knows what he wants to ask but an employee at the service counter does not know what he will be asked. When the customer asks his question, the employee first recognizes “what the customer would like to know is this”, i.e., information is shared between the customer and the employee.

In a scene where information is exchanged as a part of an information system, concerning a matter that one person knows and another person does not know, an operation for the person who does not know the matter to ask the person who knows about the matter about the thing, is “Query”. An operation for the person who knows the thing to answer to the other person who does not know the thing, is “Answer”. In a requirements analysis in the information system, it is important that who knows what and it is also important to indicate what operation solves an unknown thing.

In the embodiment, a concept of a character is introduced and the character is regarded as a container for information. A situation is an aggregate of information items and a character is also an aggregate of information items. Therefore, the character is understood as a kind of situation. In other words, the character can be regarded to represent the inner aspect of the person (inner situation).

In the embodiment, to enable handling of items other than persons, that each can retain therein information like a database, a concept of an agent is introduced as an inherited class of a character. For example, an agent that permanently has information stored therein is referred to as “database”.

In the embodiment, a snapshot is formalized, in which information is exchanged among the characters. The snapshot corresponds to a scene, and a scene is defined as a subclass of a situation. A scene includes not only a set of information items that are the definitions of a situation but also a set of characters that constitute the scene and a set of actions among the characters.

In the requirements analysis, the person in charge of the requirements analysis follows the flow of the scenes while some options may by present in a scene and plural candidates for the next scene may be present. In this case, as opposed to the set of scenes, the partial order set of the scenes that represents the sequential relation of the scenes is referred to as “script”. In a script, the scenario is changed depending on the option. To execute the management that corresponds to chaptering, each scene may be caused to further have a script.

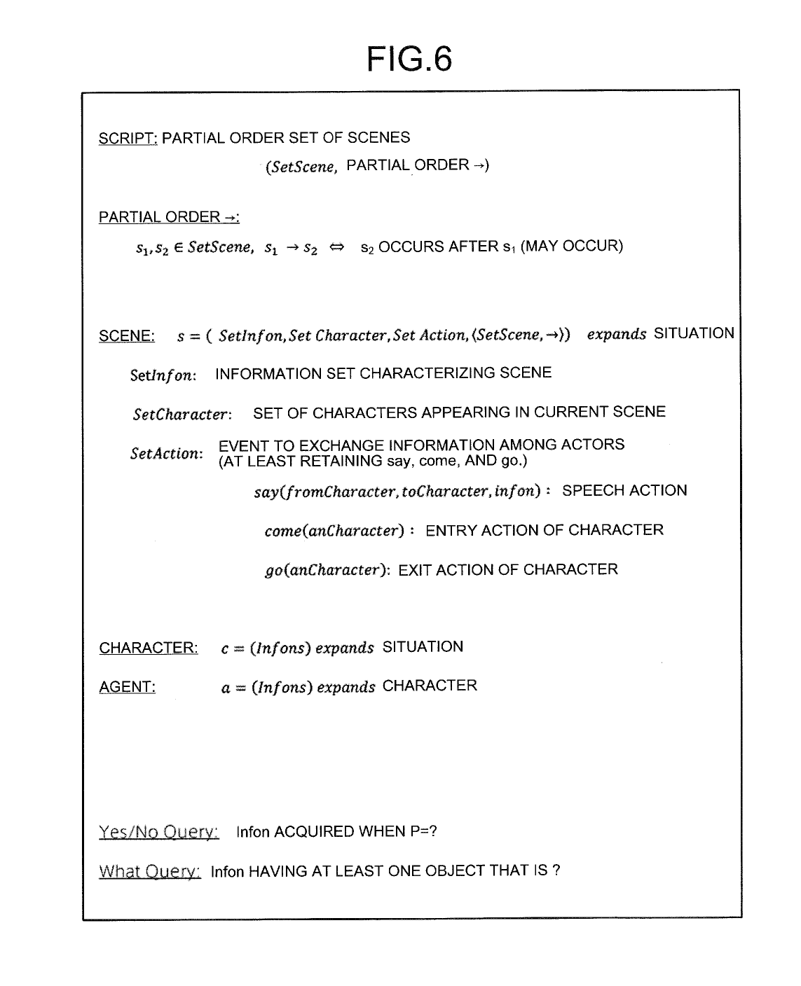

FIG. 6 is an explanatory diagram of a comics chart situation theory. In FIG. 6, a data structure defining a comics chart is defined using a formal expression. In the embodiment, the partial order sets of the concepts and the relations are global sets based basically on the definition depicted in FIG. 6. However, when a change is made to each situation, the situation may be defined as (Infon set, concept partial order set, relation partial order set).

“Infon” can be expressed by a list structure. A set can be expressed by a list or a set. A partial order set can be expressed as depicted in FIG. 4. Therefore, any one of the formalization members is a software member that is easily realized by a container. Therefore, these members can be put in a storage device such as the RAM 203 and can be put in a file by using an expression format such as an extensible markup language (XML). Therefore, a computer-readable expression is enabled for the members.

From the above, the data structure defining the comics chart can be defined by the formal expression. In executing the requirements analysis, a speech action is modeled that is executed in a scene in an assumed scenario and thereby, the person in charge of the requirements analysis using this model can execute the formalization that is intuitively understandable and that is easy to acquire agreement therefor among persons in charge of the requirements analysis. As a result, intuitive understanding is enabled and therefore, occurrence of overlooking, i.e., “unexpected event” can be suppressed and the possibility of conceiving another idea can be increased.

The formal meaning of “Infon” will be described. The “concept” is defined as expressed by Eq. (4). Eq. (4) is a connotative definition based on the set theory of the “concept”. A partial order “<” indicating an “inclusion relation of the concepts” is defined as “A<B≡A is a B”. The definition, based on the set theory, of the inclusion relation of the “concepts” is defined as expressed in Eqs. (5), (6), and (7) below.

Concept A={x|xεSetObject [symbol] x is A} (4)

A<B:(intuitive meaning) A is B. (5)

A is a B≡A<B . . . (aliacing) (6)

∀xεA[xεB] [symbol] A<B (7)

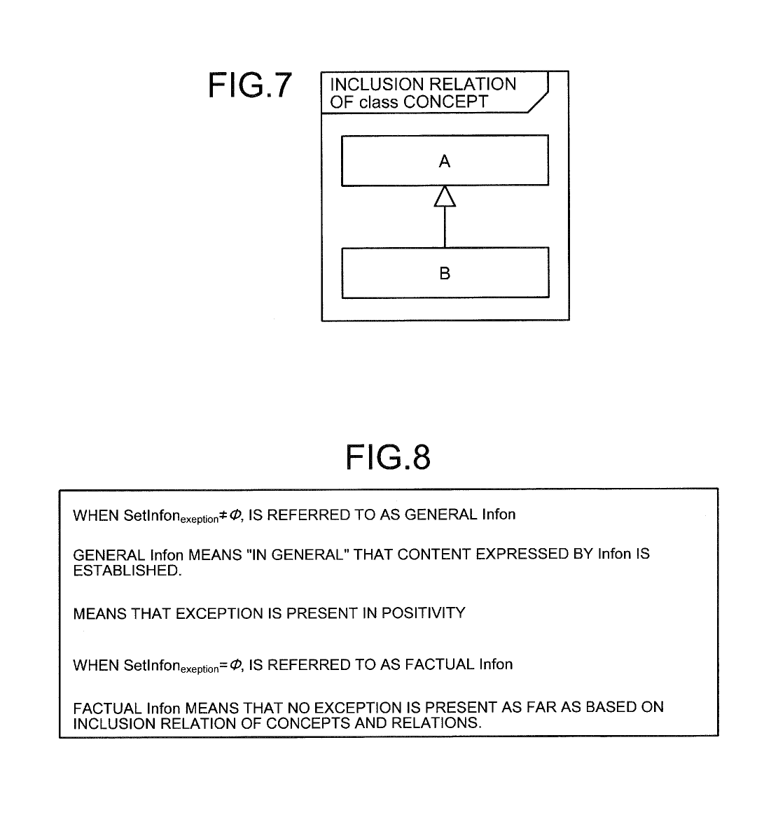

Assuming that A inherits the concept of B, when the “inclusion relation of the concepts” is described using a unified modeling language (UML), the description is made using the inheritance relation as depicted in FIG. 7.

FIG. 7 is an explanatory diagram of the inclusion relation of the concepts by the UML notation. In FIG. 7, the “inclusion relation of the concepts” is described using the inheritance relation of the concepts, and A inherits the concept of B.

The connotative definition, based on the set theory, of the “relation” is defined as expressed by Eq. (8) below and the definition, based on the set theory, of the inclusion relation of the “relations” is defined as expressed in Eq. (9) below.

Relation R₀={R|RεSetRelation [symbol] To R is to R₀} (8)

e.g.) Assuming that relations “Run” and “Move” are present and “To run is to move.” is established, Run_{ε}Move.

R₀<R₁:(intuitive meaning) relation R₀ is a more specific relation than relation R₁ (9)

∀xεR₀[xεR₁] [symbol] R₀<R₁

Thereby, an inclusion relation is established between the “concept (a word like a noun)” and the “concept (a word like a verb)”. As above, the information is expressed by the tuple notation of the relation, the plural concepts, and the polarity. The concept expressed by the tuple notation of the relation and the plural concepts is referred to as “relation nature”.

The nature of the inclusion relation of the “relation natures” can be derived as expressed in Eq. (13) below when: the “relation nature” is defined as expressed in Eq. (10) below; the definition, based on the set theory, of the “relation nature” is defined as expressed in Eq. (11) below; and the inclusion relation of the “relation natures” is defined as expressed in Eq. (12) below.

Relation nature RS=[R,O₀, . . . ,Oₙ] (10)

R: relation
O₁: object

It is assumed that relation nature RS₀=[R, O₀, . . . , Oₙ]. In this case,

Relation nature

RS₀={[r,o₀, . . . ,oₙ]|rεR [symbol] o₀εO₀ [symbol] . . . [symbol] oₙεOₙ} (11)

It is assumed that [R, O₀, . . . , Oₙ, P], RS′₀=[R′, O′₀, . . . , O′ₙ, P′]. In this case,

RS₀<RS′₀ [symbol] ∀xεRS′₀[∀xεRS′₀] (12)

It is assumed that RS₀=[R, O₀, . . . , Oₙ, P], RS′₀=[R′, O′₀, . . . , O′ₙ, P′]. In this case,

((R<R′) [symbol] (O₀<O′₀) [symbol] . . . [symbol] (Oₙ<O′ₙ) [symbol] RS₀<RS′₀ (13)

is established.

Functions of Infon and the relation nature are defined as expressed in Eqs. (14), (15), and (16) below. Eq. (14) is the function of “Infon-relation nature”. Eq. (15) is a polarity function. Eq. (16) is a function of “relation nature→Infon”.

Fir: [symbol] R,O₀, . . . ,Oₙ,P [symbol] [symbol] [R,O₀, . . . ,Oₙ] (14)

Fp: [symbol] R,O₀, . . . ,Oₙ,P [symbol] [symbol] P (15)

Fri:([R,O₀, . . . ,Oₙ],P) [symbol] [symbol] R,O₀, . . . ,Oₙ,P [symbol] (16)

Mapping of the relation nature from Infon, mapping from Infon to the polarity, and mapping from the relation nature and the polarity to Infon are enabled by using Eqs. (14) to (16). The meaning based on the set of Infon will be described.

The definition of Infon, based on the set theory is defined as expressed in Eqs. (17), (18), and (19) below. A method (s, Fsem(i)) of extracting the meaning of “Info i” in a situation “s” is defined as expressed in Eq. (20) below.

I means [symbol] SetInfon_{succession},SetInfon_{exception} [symbol] (17)

SetInfon_{succession}={i|iεSetInfon [symbol] (Fp(i)=Fp(l)) [symbol] (Fir(i)<Fir(l))} (18)

SetInfon_{exception}={i|iεSetInfon [symbol] (Fp(i)≠Fp(l)) [symbol] (Fir(i)<Fir(l))} (19)

s·Fsem:I [symbol] [symbol] SetInfon_{succession},SetInfon_{exception} [symbol] (20)

A method for a tuple object is defined as expressed in Eq. (21) below. “_k” is a method of extracting a k-th tuple member. The inclusion relation of Infon is defined as expressed in Eq. (22) below.

[symbol]

a₁, . . . ,aₙ [symbol] ·_{—}k=aₖ (21)

I₀<I₁ [symbol] ((I₀·_{—}1⊂I₁·_{—}1) [symbol] (I₀·_{—}2⊂I₁·_{—}2)) (22)

The definitions of Eqs. (17) to (22) each represent creation of the meaning based on the partial order sets of the concepts and the relations. Infon is defined, based on the set theory, by the tuple of the two sets. Operationally described: for the current Infon I, a set of “i”s that each establish “the relation nature of i (=Fir(i))<the relation nature of I (=Fir(I))” is extracted; a set of Infons whose polarities are same as that of I and a set of Infons whose polarities are different from that of I are separated from each other; and these sets are respectively denoted by SetInfon_{succession} and SetInfon_{exception}. This tuple is set to be the meaning of I.

FIG. 8 is an explanatory diagram of the classification of Infon based on the nature thereof. FIG. 8 depicts the classification of Infon using the inclusion relation of the concept and the relation. For example, it is defined that the classification is executed based on whether SetInfon_{exception} is an empty set and that the empty set is referred to as “factual Infon” and the non-empty set is referred to as “general Infon”.

The “factual Infon” means that a member I of the Infon set is consistent compared to an arbitrary member of the Infon set from the viewpoint of the partial order sets of the concepts and the relations. On the other hand, for the general Infon, a discrepancy is present based on a strict determination. However, the discrepancy of this nature may occur in, not to mention, general speech and even in the requirements analysis. Therefore, this is not handled as a discrepancy but is interpreted as a general statement and an exceptional statement. An example of the interpretation of the general Infon will be described.

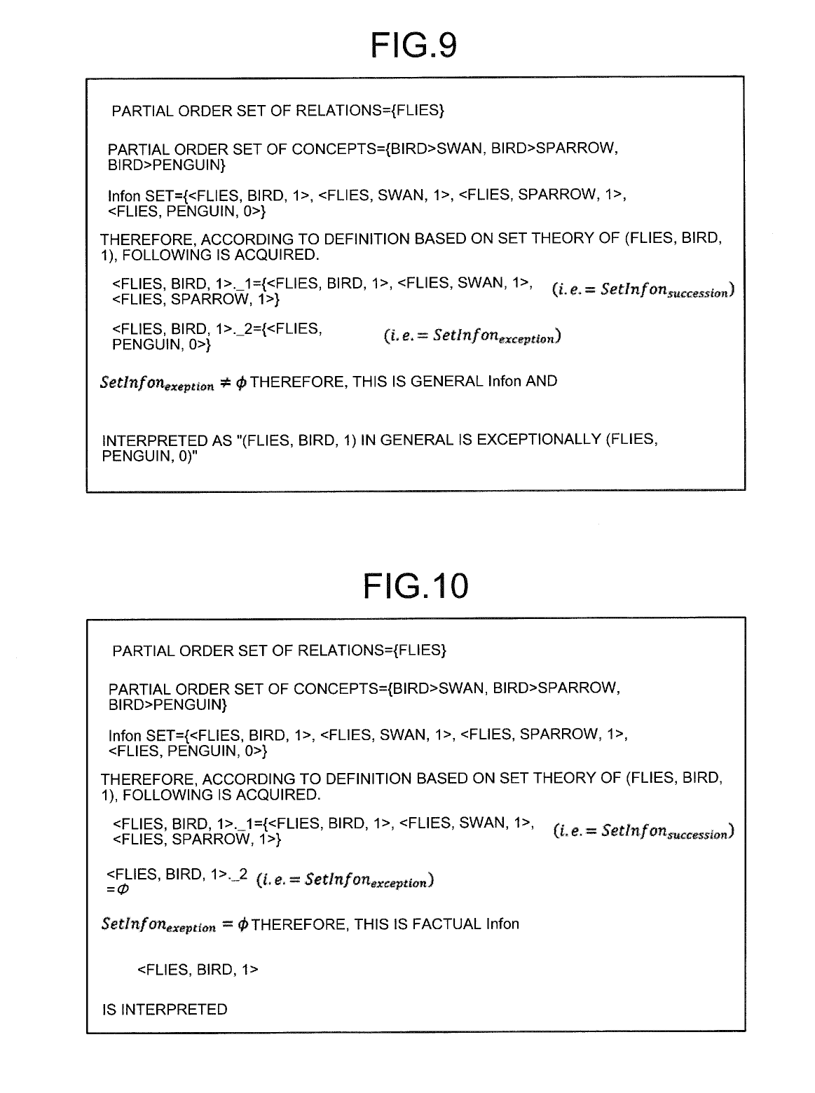

FIG. 9 is an explanatory diagram of an example of the interpretation of the general Infon. A case is assumed where a partial order set of the relations, that of the concepts, and an Infon set are present. In this case, when the meaning of <flies, bird, 1> is created based on the definition based on the set theory of Infon, SetInfon_{exception}={<flies, penguin, 0>] is present.

Therefore, for the Infon set in FIG. 9, <flies, bird, 1> is a general Infon. This interpretation provides “<flies, bird, 1> in general while <flies, penguin, 0> as an exception” as depicted in FIG. 9. In other words, “A bird flies while a penguin does not fly”.

As above, when a meaning is created based on the definition based on the set theory, of Infon, extraction is enabled of an exceptional statement that is implied by the member I in the Infon set, based on the Infon set, the partial order set of the relations, and the partial order set of the concepts. An example of the interpretation of a factual Infon will be described.

FIG. 10 is an explanatory diagram of an example of the interpretation of the factual Infon. It is assumed that such sets are present as the partial order set of the relations, the partial order set of the concepts, and the Infon set as depicted in FIG. 10. This represents the situation where <flies, penguin, 0> is not present for FIG. 9.

In this case, when the meaning of <flies, bird, 1> is created based on the definition based on the set theory, of the Infon, SetInfon_{exception} is an empty set. Therefore, <flies, bird, 1> is a factual Infon. Seen from the Infon set, no especially exceptional information is present and, seen from the Infon set, the information is information that is determined to be a fact.

FIGS. 9 and 10 include a difference therebetween that is important for considering the situation. As above, the situation is the Infon set, and the scene, the characters, and the agent are the inherited classes of the situation. When the Infon sets of FIGS. 9 and 10 are regarded as the characters (the situation concerning the knowledge of each character), FIG. 10 depicts the situation that has therein the recognition that <flies, bird, 1> is a fact. It is assumed that this character acquires information that is <flies, penguin, 0>.

In this case, the Infon set represents the knowledge of the characters and therefore, the acquired <flies, penguin, 0> needs to be added to the Infon set. Thereby, the set becomes the Infon set of FIG. 9. Therefore, the recognition of the characters at this time point is changed to “<flies, bird, 1> in general while <flies, bird, 0> exceptionally”.

This type of utterance is often used in the daily life of people and it can be seen that the definition, based on the set theory, of Infon provides a natural meaning. It can also be considered that the same manner of receiving information is employed as the manner for a person to receive knowledge of an exception.

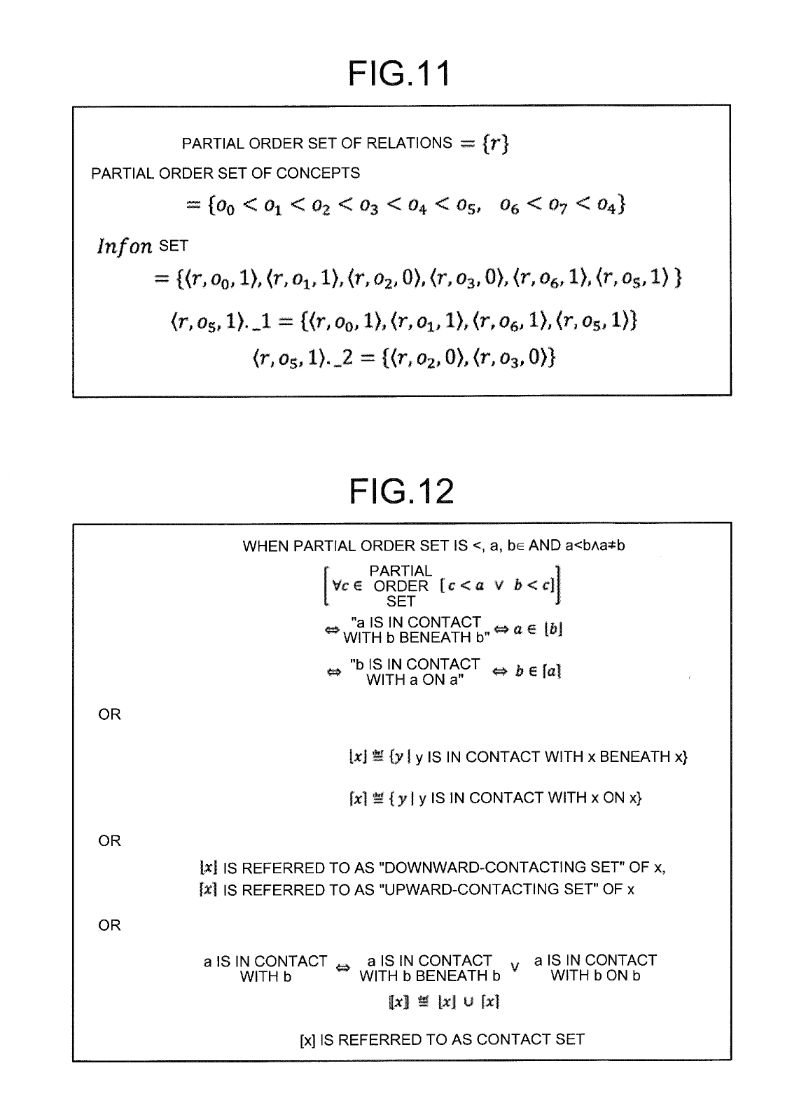

FIG. 11 is an explanatory diagram of an example of Infon that has a complicated meaning. In FIG. 11, the meaning is created for <r, o₅, 1> based on the definition based on the set theory, of Infon. <r, o₀, 1> is implied by <r, O₁, 1>. Similarly, <r, o₂, 0> is implied by <r, O₃, 0>.

In an aspect, Infon implied by another piece of Infon (for example, <r, o₀, 1> and <r, O₂, 0>) is regarded to be redundant. Therefore, in the embodiment, the analysis support apparatus 101 removes the Infon implied by another Infon. In the following description, a process of removing the Infon implied by another Infon (logic abridgement) is referred to as “abridgement of the Infon set”. The definition is made for the partial order set as depicted in FIGS. 12, 13, and 14.

FIG. 12 is an explanatory diagram of the definition of the concept in the partial order set. FIG. 12 depicts the definitions of “in contact”, “upward-contacting set”, “downward-contacting set”, and “contacting set”.

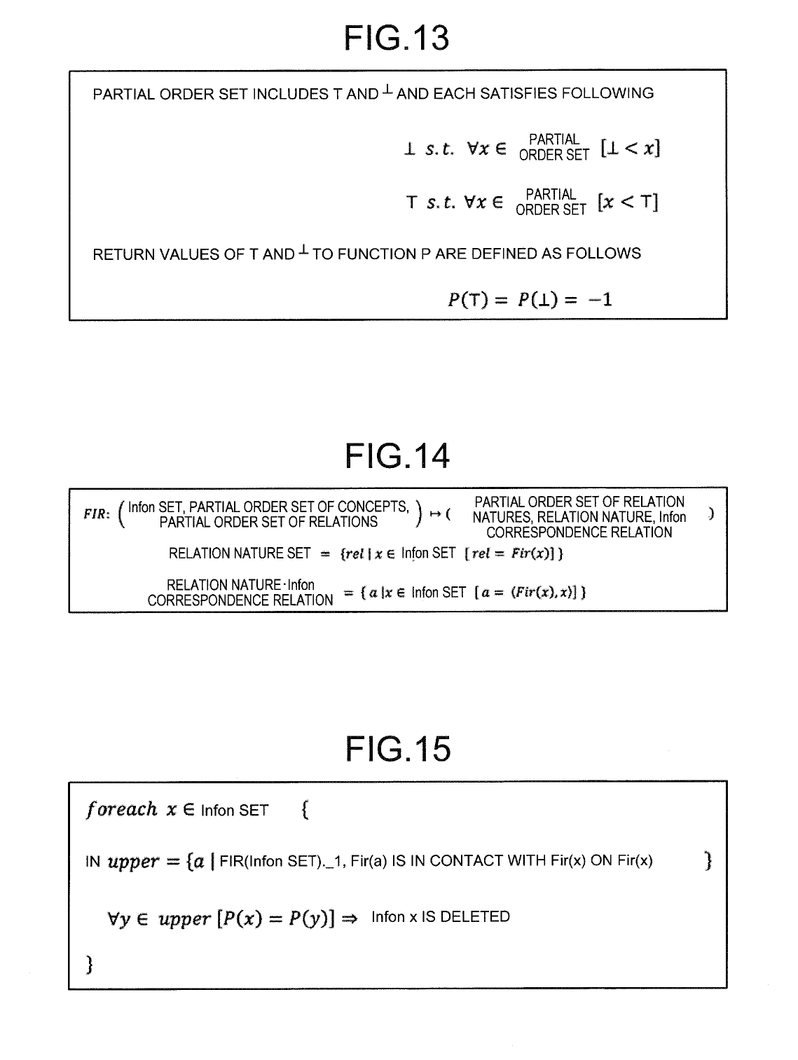

FIG. 13 is an explanatory diagram of the definition of a top member and of a bottom member. FIG. 13 depicts the condition to be satisfied by “T” and “⊥” included in the partial order set.

FIG. 14 is an explanatory diagram of the definition of a function of acquiring the partial order set of the relation natures. In FIG. 14, the function FIR of acquiring the partial order set of the relation natures is defined. The partial order set of the relation natures is acquired from the nature of the inclusion relation of the relation natures expressed Eq. (13).

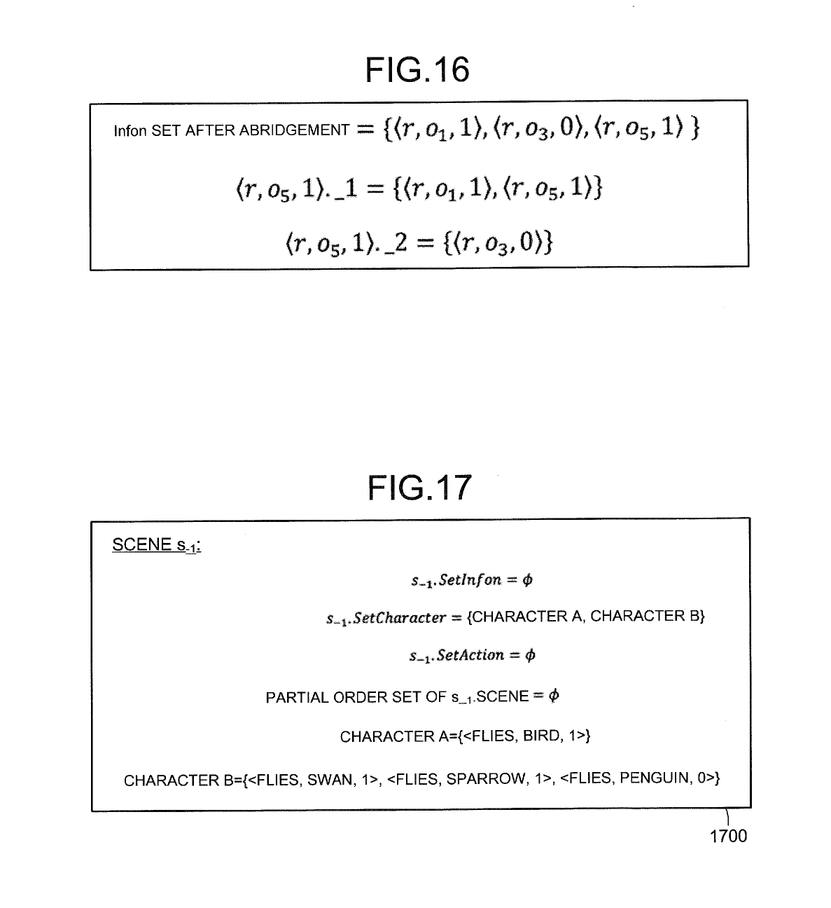

FIG. 15 is an explanatory diagram of an example of an abridgement algorithm. According to the abridgement algorithm depicted in FIG. 15, the analysis support apparatus 101 can abridge the Infon set depicted in FIG. 11 to an Infon set depicted in FIG. 16.

FIG. 16 is an explanatory diagram of an example of the result of application of the abridgement algorithm. FIG. 16 depicts the result of the application of the abridgement algorithm depicted in FIG. 15 to the Infon set depicted in FIG. 11. For example, the meaning that is “<r, o₅, 1> in general, and exceptionally <r, o₂, 0> and <r, o₃, 0>” in FIG. 11 can be abridged to “<r, o₁, 1> in general and exceptionally <r, o₃, 0>” in FIG. 16.

In the above, the case has been described where the Infon implied by another Infon is excluded, that is, deleted. However, the Infon implied by the other Infon may be covered (hidden). Thereby, when the abridgement becomes unable due to newly input Infon, the hidden Infon can be revived.

In the following description, when a query is considered, the case is assumed where an Infon set is abridged.

As above, in the mathematical creation of the meaning, information (Infon) and a dictionary (the concept partial order set and the relation partial order set) are separated from each other to create their meanings. The information is changed according to the situation, and each of “right”, “wrong”, “valuable”, and “unvalued” is determined based on the knowledge retained at the time point of the utterance.

On the other hand, the concept is the knowledge whose changes are expected to relatively be few. People produce dictionary knowledge items whose universality may be admitted to some extent, and other knowledge items that are each produced by combining the dictionary knowledge items and that each refer to the situation of the time point or knowledge items that each represent more complicated intellect and thereby, share the intellect.

The dictionary knowledge has universality, is used to produce information and to recognize the relations among the information, and is the knowledge for a person to know exhaustively to some extent. On the other hand, depending on the case, information merely has to be able to execute meaningful information transmission in a specific scene (situation) and therefore, has a short life.

Therefore, it is fruitful to consider the informational knowledge and the dictionary knowledge separating these from each other. What is highly important is the amount of informational knowledge. Even the amount of the dictionary knowledge is large while the amount of the information is huge for combinations of the informational knowledge and the dictionary knowledge. Therefore, it is important: how compactly the information has to be retained; or to produce and consume the information that is necessary for the scene.

Although the informational knowledge characterizes a scene, the informational knowledge may not be retained as is in a dictionary. A book is present between a dictionary and an utterance and the book is regarded as an aggregate of informational knowledge. Therefore, an item like a book is also apprehended to be an agent. The content described in the book can be regarded to be one situation.

The book has its own purpose, has therein pieces of information collected for the purpose and therefore, does not always assert its universality. The book has therein useful information that is collected when a scene is considered. Taking this point into consideration, it is considered that it is natural that a book is regarded as a type of situation.

As above, the formalization based on the mathematical semantic theory, that is executed in the embodiment naturally formalizes the manner for the information, the knowledge, and the formal intellect (written intellect (such as a book)) to be handled in the daily life of people. It is considered that the requirements analysis formalizes to debug the thoughts of people. It is also considered that the requirements analysis is a process of scrutinizing what is formalized and reviewing what production enables creation of better daily living.

Therefore, the formalization is formalization matched with the intuition of a person and one of the elements of the requirements analysis is an element of the personality to debug the thought of the person. It can be seen that the formalization is suitable as formalization of the thought for the requirements analysis and is formalization that can reproduce on a computer a thing that is same as an inference executed by an ordinary person. To be able to reproduce the thing that is same as the inference executed by the ordinary person means that the individuals involved who execute the requirements analysis do not have to execute any inference and interpretation to fill in the gaps between their thought patterns and the formalization reproduced on the computer.

As above, the formalization is executed by intuitively formalizing the thoughts of people, and a tool formed by reproducing the formalization on the computer can realize expressions that are close to the thoughts of people. The information for the concept is constituted of an item whose truth can be determined. However, the formalization is established with which no truth is determined for information. The formalization can apprehend even the factors that seem to be so inconsistent that the formalization using the mathematical logics can not permit.

One of the features of the formalization is that, though the information is formalized and the rules for the inference are determined, the formalization functions even when the information set is incomplete or has inconsistency. It is considered that a person extracts more valuable information using incomplete information. Therefore, it can be stated that: this incomplete state can be handled in the framework of the formalization; and this indicates that the formalization is human-friendly formalization.

In the initial design reviewing phase where an ambiguous requirement is desired to be clarified, the information can not be completed and therefore, the formalization is important that functions even when the information is incomplete. The meaning of Infon includes exceptions due to the definition, based on the set theory, of Infon. Therefore, it is considered that an answer including information for the exceptions, rather than the Infon as an answer, is returned.

A case example of a comics chart will be described. An example of the partial order sets of the concepts and the relations that are dictionary information and an example of the script will first be provided. The partial order sets of the concepts and the relations that are dictionary information, are stored in a storage device such as the RAM 203.

The partial order set of the relations={flies}

The partial order set of the concepts={bird>swan, bird>sparrow, bird>swallow, bird>penguin}

script={s₋₁→s₀→s₁→s₂→s₃→s₄→s₅→s₆→s₇}

Examples of scenes will be provided. FIGS. 17 to 25 are explanatory diagrams of examples of scenes. In FIGS. 17 to 25, the “scene:” is a scene ID to identify a scene. “SetCharacter” denotes a character set. “SetAction” denotes an action set. “Character={ }” denotes a knowledge set of a character.

FIG. 17 depicts scenario information 1700 of a scene_{S-1}. The scene_{S-1} is a scene in the initial setting. For example, a “character A” and a “character B” are set as the characters therein. “<flies, bird, 1> is set as a knowledge item of the character A. <flies, swan, 1>, <flies, sparrow, 1>, and <flies, penguin, 0> are set as knowledge items of the character B.

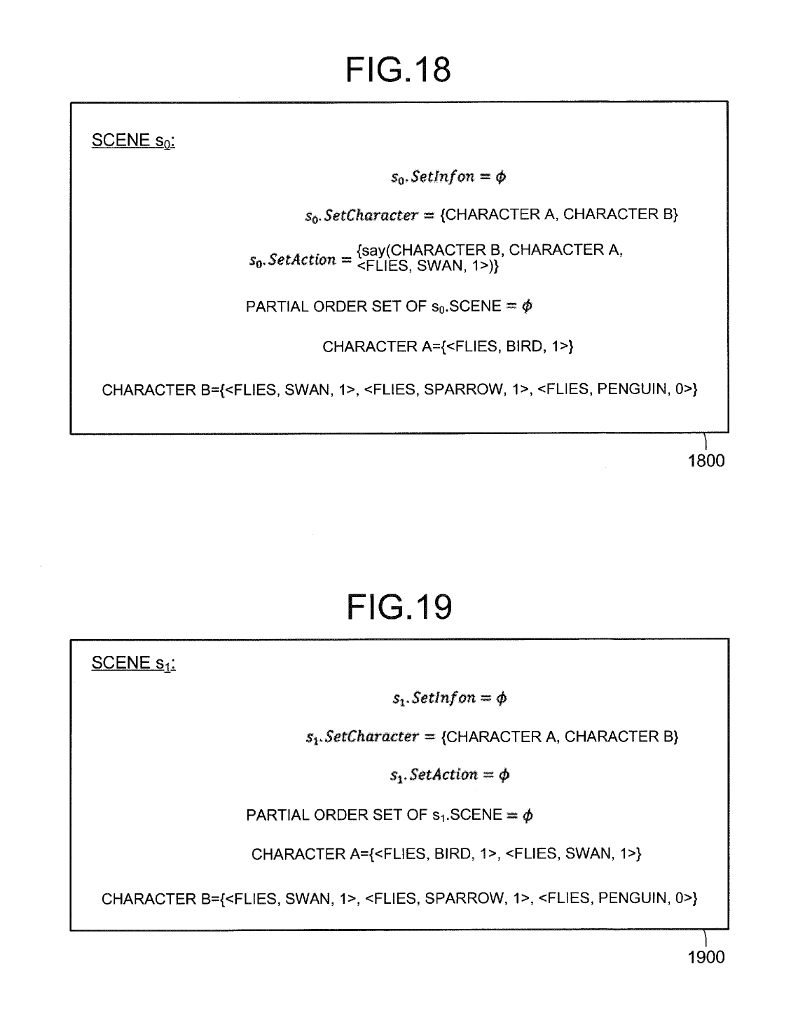

FIG. 18 depicts scenario information 1800 of a scene_{S0}. In the scene_{S0}, a “say” action is input by an operational input by the user. For example, the “say” action of <flies, swan, 1> from the character B to the character A is input. “<flies, swan, 1> represents the meaning that “a swan flies”. Although the tuple notation is used in FIG. 6, for facilitation of readability, “s0·SetInfon” is written instead of writing as “_{S0}·_{—}1”.

FIG. 19 depicts scenario information 1900 of a scene_{S1}. For example, in the scene_{S0}, the analysis support apparatus 101 receives a switching instruction for the scene by an operational input by the user and produces the scene_{S1}. For example, the analysis support apparatus 101 executes the “say” action of the scene_{S0}.

The “say” action means that, when, for example, the situation of a first argument (the character B) retains the value of a third argument (<flies, swan, 1> of the “say” action), the value of the third argument is copied from the first argument to a second argument (the character A). As a result, the scene is switched from the scenes to the scene_{S1}.

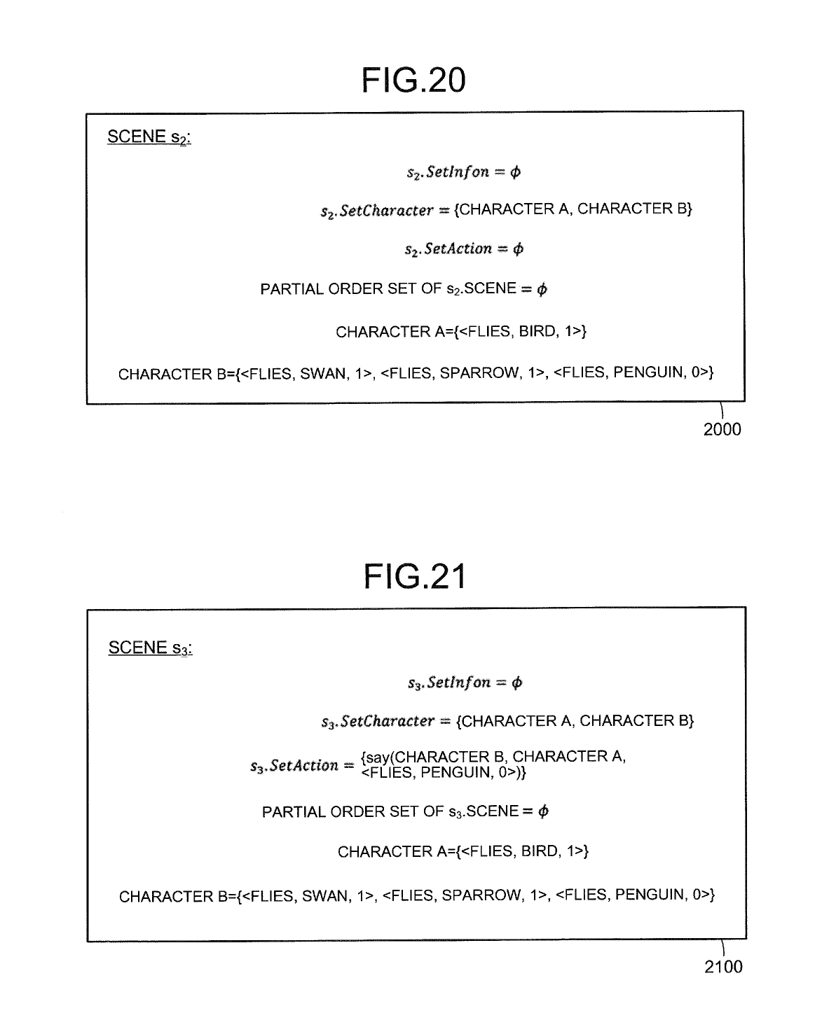

FIG. 20 depicts scenario information 2000 of a scene_{S2}. In the scenes_{S1}, the situation of the character A is changed. Therefore, the analysis support apparatus 101 executes data reduction by applying, for example, the abridgement algorithm. In the example of FIG. 20, the character A returns to the scene_{S0}.

It can be seen that the speech of the character B has no affect on the character A. Describing the situation using the speeches, the character B speaks “A swan flies.” and, as a result, the character A speaks something like “Really? That's true. A swan is a bird and it flies”. Therefore, it can be seen that the dialogue can naturally be modeled.

FIG. 21 depicts scenario information 2100 of a scene_{S3}. In the scene_{S3}, a “say” action is input by an operation input by the user. For example, the say action of <flies, penguin, 0> from the character B to the character A is input. “<flies, penguin, 0> represents the meaning that “a penguin does not fly”.

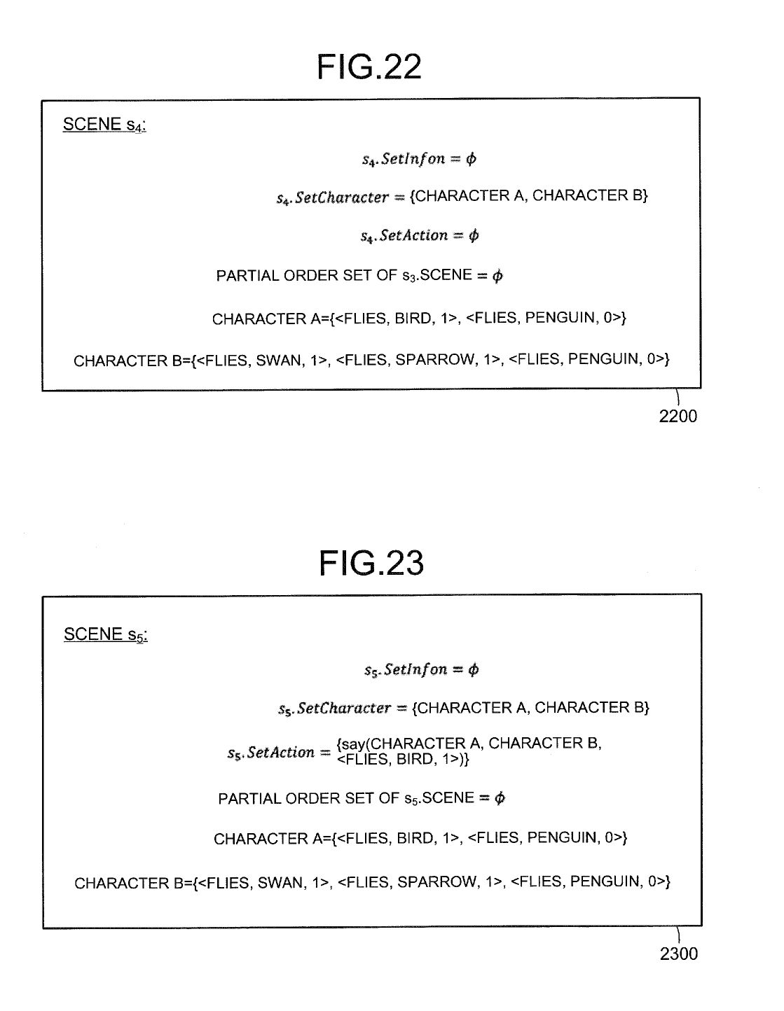

FIG. 22 depicts scenario information 2200 of a sceneₛ₄. For example, in the scene_{S3}, the analysis support apparatus 101 receives a switching instruction for the scene by an operational input by the user and produces the scene_{S4} by executing the “say” action of the scene_{S3}. As a result, the scene is switched from the scene_{S3} to the scene_{S4}.

In the scene_{S4}, the situation of the character A is changed. Therefore, the analysis support apparatus 101 executes data reduction by applying, for example, the abridgement algorithm. In the example of FIG. 22, the situation of the character A is not changed. In this case, it can be seen that the character A is influenced by the speech of the character B.

Describing the situation using the speeches, the character B speaks “A penguin does not fly.” and, as a result, the character A speaks something like “Really? A penguin doesn't fly? Although the penguin is a bird, it does not fly. I will remember that”. Therefore, it can be seen that the dialogue can naturally be modeled.

FIG. 23 depicts scenario information 2300 of a scene_{S5}. In the scene_{S5}, a “say” action is input by an operation input by the user. For example, the “say” action of <flies, bird, 1> from the character A to the character B is input.

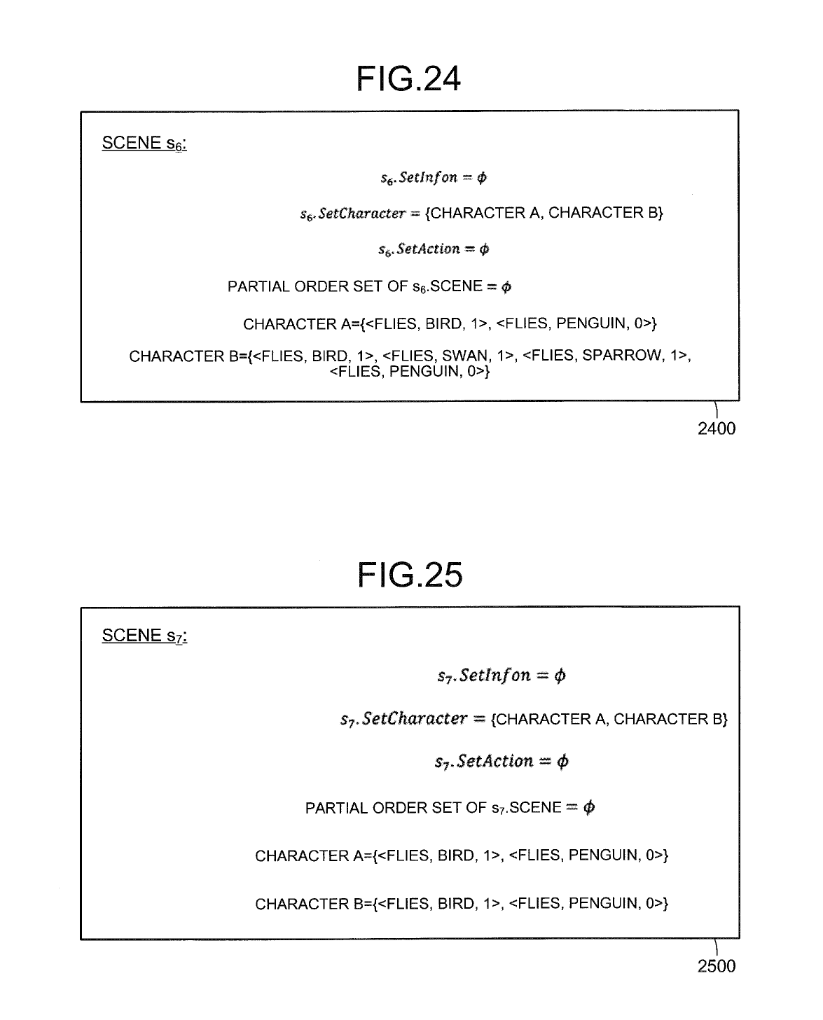

FIG. 24 depicts scenario information 2400 of a scene_{S6}. For example, in the scene_{S5}, the analysis support apparatus 101 receives a switching instruction for the scene by an operational input by the user and produces the scene_{S6} by executing the “say” action of the scene_{S5}. As a result, the scene is switched from the scenes to the scene_{S6}.

FIG. 25 depicts scenario information 2500 of a scene_{S7}. In the scene_{S6}, the situation of the character B is changed. Therefore, the analysis support apparatus 101 executes data reduction by applying, for example, the abridgement algorithm. In the example of FIG. 25, <flies, swan, 1> and <flies, sparrow, 1> are removed from the situation of the character B.

Describing the situation using the speeches, the character A speaks “First of all, birds fly.” and the character B thinks “They sure do. A sparrow and a swan are birds and, so, they fly. I don't need to remember this”. Therefore, it can be determined that the knowledge system is changed to the one according to which the information the knowledge is forgot as information (Infon) and, when necessary, the inference only has to be executed based on {<flies, bird, 1>, <flies, penguin, 0>} and the partial order sets of the concepts and the relations.

As above, the comics chart is a framework with which an effect on an item retaining information can intuitively be grasped using a speech.

A trial can be made as to what happens when an action of “say (character B, character A, <flies, penguin, 0>)” is taken in the scenes_{S2}, as another method of using the comics chart. The transition of the scenes can be observed based on the dialogue. The script may be linear as above or may have a tree structure as follows.

Script={s₋₁→s₀→s₁→s₂,s₋₁→s₃→s₄→s₅→s₆→s₇}

In this case, the development of the scene differs between the difference between the scenes_{S-1} and the scene_{S0} and the difference between the scenes_{S-1} and the scene_{S3}, i.e., between “_{S0}·SetAction={say (character B, character A, <flies, swan, 1>)}” and “_{S3}·SetAction={say (character B, character A, <flies, penguin, 0>)}”.

Two options are present for the scene_{S-1} and the succeeding scene development differs depending on which speech is made. Therefore, the user can select the scene development by selecting a speech. As above, a script can be defined that has multiple scene development and therefore, based on the action in each situation, the user can intuitively grasp what happens thereafter.

In the formalization, the concepts and the relations are defined as the partial order sets and therefore, multiple inheritance is allowed. In this case, the polarity of Infon may not be able to be determined based on the partial order sets of the concepts and the relations (unknown Infon).

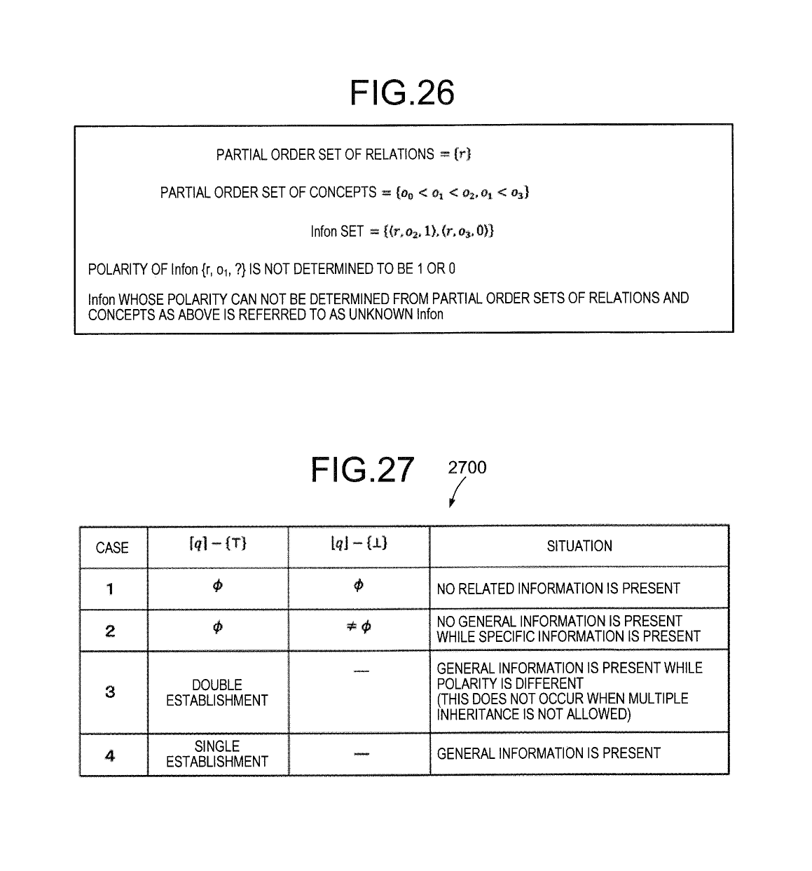

FIG. 26 is an explanatory diagram of an example of the unknown Infon. FIG. 26 depicts the partial order sets of the relation and the concepts, and the Infon set. The polarity of Infon<r, o₁, ?> is not determined to be “1” or “0”. As above, the Infon whose polarity can not be determined based on the partial order sets of the relations and concepts is referred to as “unknown Infon”. On the other hand, when multiple inheritance is prohibited, no unknown Infon is generated.

The definition of “Query-Infon” will be described. The formal definition of “Query-Infon” is defined as expressed in Eqs. (23) and (24). It is assumed that “What type Query” includes one or more “?”. “Query-Infon” is written for a query in FIG. 6.

[symbol]

r,o₁, . . . ,oₙ,? [symbol] (23)

[symbol]

r,o₁, . . . ,oₖ₋₁,?,oₖ₊₁, . . . ,oₙ,1 [symbol] , [symbol] r,o₁, . . . ,oₖ₋₁,?,oₖ₊₁, . . . ,oₙ,0 [symbol] (24)

In the embodiment, the definition expressed in Eqs. (23) and (24) is acknowledged as an expansion of Infon and may be included in the Infon set. The expansion enables Infon indicating a query, to be newly introduced. When this is acknowledged as Infon and is included in the situation, an interrogative sentence can be introduced into the situation.

For example, a character is an inherited class of a situation and therefore, can have Infon that indicates an interrogative sentence. Thereby, a state can be expressed where the character has an interrogative sentence. For the information system, the user asks a question of an expert and acquires the information requested by the user. The introduction of the Infon indicating the interrogative sentence enables a state to be expressed where the interrogative sentence is retained, by including the Infon that indicates the interrogative sentence in the situation.

A query of a YES-or-NO type will be defined. In the embodiment, no precondition exists that the set of the information items be free of discrepancy. Therefore, the information items may be inconsistent with each other. The basic form of the YES-or-NO Query is defined as expressed in Eq. (25) below.

if Fir(q)εFIR(Infon set)·_{—}1

answer=P(FIR(Infon set)·_{—}2(Fir(q))

else

answer=Derive(Infon set,q) (25)

In Eq. (25), when Infons are present whose relation natures are same, it is defined that these Infons are returned. However, though the definition is described as above for simplicity, the analysis support apparatus 101 in practice returns the result acquired by further executing, in the situation of the speaker, meaning interpretation as in the definition, based on the set theory, of Infon as above.

Thereby, information can be returned that concerns the general case and the exception. When the Infons are not present whose relation natures are same, the analysis support apparatus 101 returns an answer by executing some inference. In this case, the inference function is written as “Derive(Infon set, q). Prior to defining the inference, the upward-contacting set and the downward-contacting set are defined as expressed in Eqs. (26) and (27) below.

Upward-contacting set ┌x┐ of Infon x={y|yεInfon set [symbol] Fir(y)ε┌Fir(x)┐} (26)

Downward-contacting set └x┘ of Infon x={y|yεInfon set [symbol] Fir(y)εFir(x)┘} (27)

When no same relation natures are present, the relations between the Infon of the query and the Infons of the Infon set can be classified as indicated in a classification table 2700 depicted in FIG. 27.

FIG. 27 is an explanatory diagram of a specific example of the classification table 2700. In FIG. 27, the classification table 2700 indicates the classification of the relations between the inquiry Infon “q” of the YES-or-NO type and the Infon set.

A case is assumed where the polarities of all the members of the upward-contacting set are same (single establishment, case 4). In this case, the generality is matched and therefore, the rules for the inference are determined as expressed in Eqs. (28), (29), and (30) below and thereby, the value is determined. The analysis support apparatus 101 may interpret as expressed in Eqs. (17) to (20) above and may return an exception set. The definition of a polarity value assigning function is defined as expressed in Eq. (31) below.

q= [symbol] r,o₁, . . . ,oₙ,? [symbol] (28)

∃pε{0,1},∀xε┌q┐[P(x)=p] [symbol] “┌q┐ is a singleton” (29)

∃pε{0,1},∀xε┌q┐[P(x)=p] [symbol] Answer is Fap(q,p) (30)

q= [symbol] r,o₁, . . . ,oₙ,?

[symbol]

$$Fap ( q , p ) {=}^{def} 〈 r , {o}_{1} , … , {o}_{n} , p 〉 \qquad ( 31 )$$

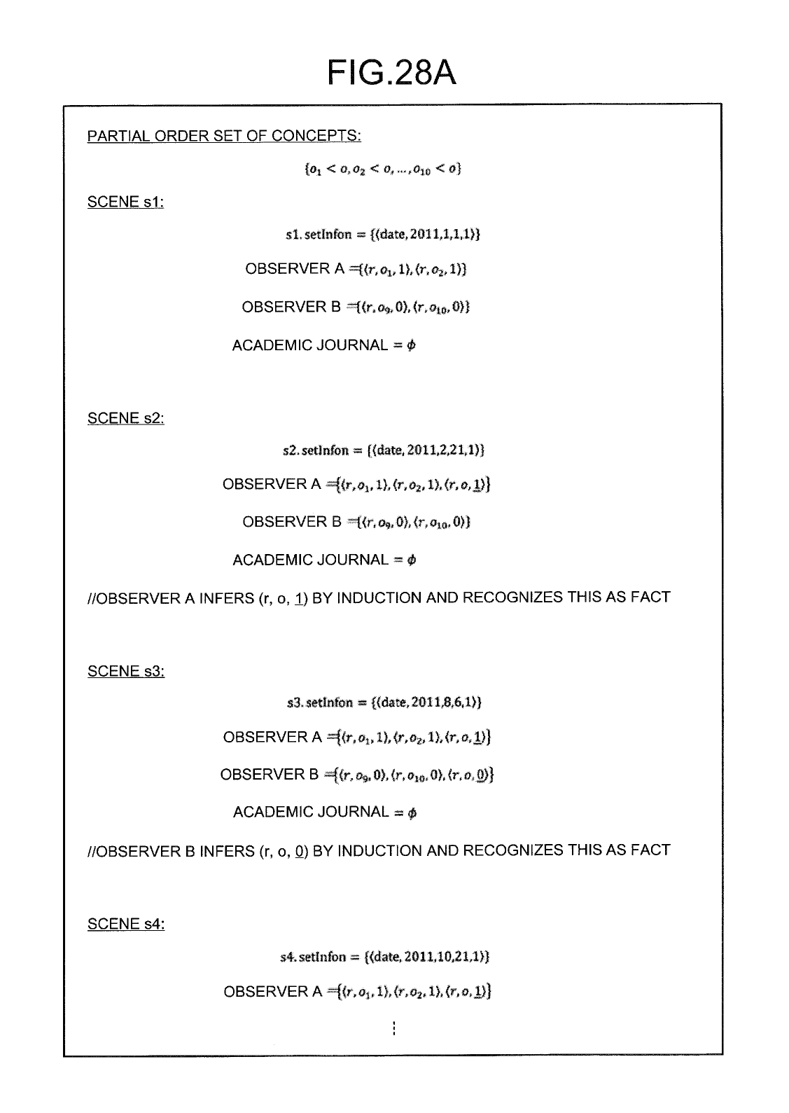

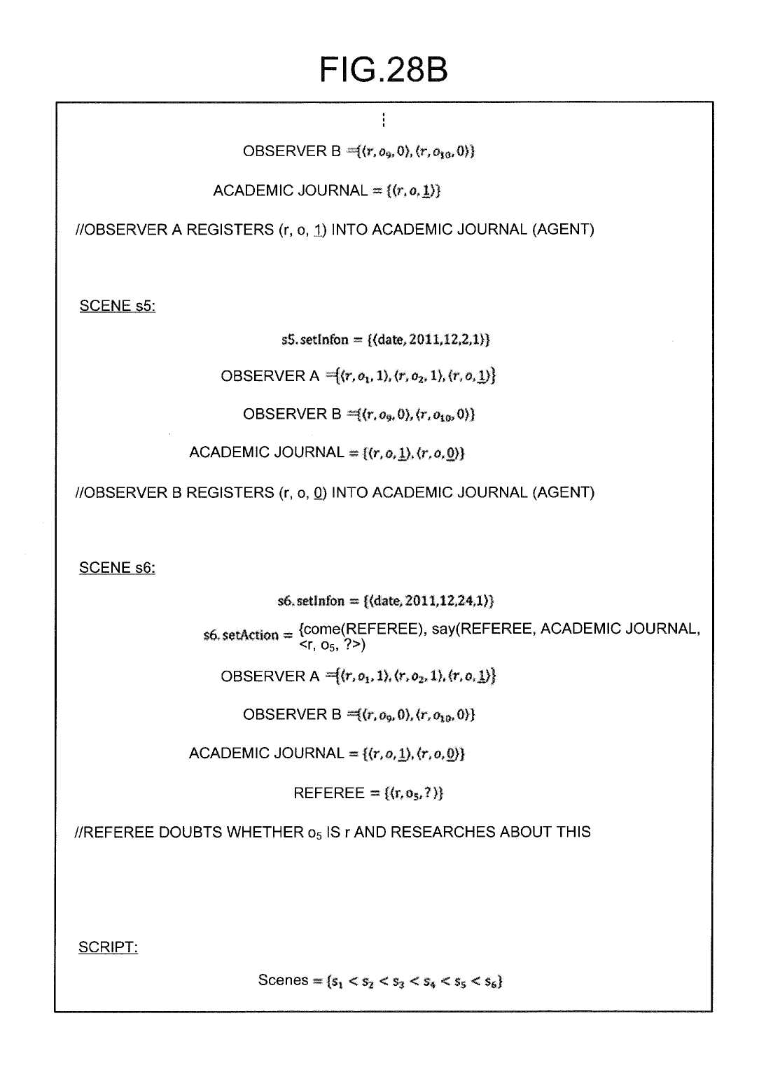

Using a comics chart depicted in FIG. 28, an example of a case will be described where information having the generality is present while an affirmative assertion and a negative assertion are present.

FIGS. 28A and 28B are explanatory diagrams of an example of a comics chart taking an example of academic research. In a scene s1 depicted in FIG. 28A, two characters are present and each of the characters has information for a concept that is different from that of the other character. In a scene s2 depicted in FIG. 28A, an observer A inductively derives Eq. (32) below (the polarity value is underlined to indicate that the value is the result of the induction).

[symbol]

r,o,1 [symbol] (32)

In a scene s3 depicted in FIG. 28A, an observer B inductively derives Eq. (33) below.

[symbol]

r,o,0 [symbol] (33)

Each of the observers determines that the induction is right. The observers A and B each register an assertion thereof in an academic journal respectively in a scene s4 depicted in FIGS. 28A and 28B, and in a scene s5 depicted in FIG. 28B. Thereafter, a referee enters who doubts whether a relation “r” can be established for “o₅” that corresponds to an inherited class of “o” and inquires of the academic journal whether the relation “r” can be established for “o₅”.

This case corresponds to a case 3 indicated in the classification table 2700 based on Eq. (34) below.

┌ [symbol] r,o₅,? [symbol] ┐={ [symbol] r,o,1 [symbol] , [symbol] r,o,0 [symbol] } (34)

In this case, it is unknown whether either one of the inductions is wrong or both of the inductions are wrong. However, assuming that both information items have grounds, it can be stated that the information items are meaningful. An answer as expressed in Eq. (35) below is returned.

r₀,o₅,undetermined> because<{r,o,1>},{<r,o,0>)}> (35)

In other words, this results in “It can not be determined that o5 is r. Because opinions are present that is r and that o is not r”. This state is referred to as “double establishment” because two opposing opinions are established. People exchange not only information whose truth is assured but also information whose truth is not assured. Therefore, the above situation is permitted. For the requirements analysis, the task is construction of a system including no discrepancy by refining. Therefore, it is better for the above situation to also be able to be handled.

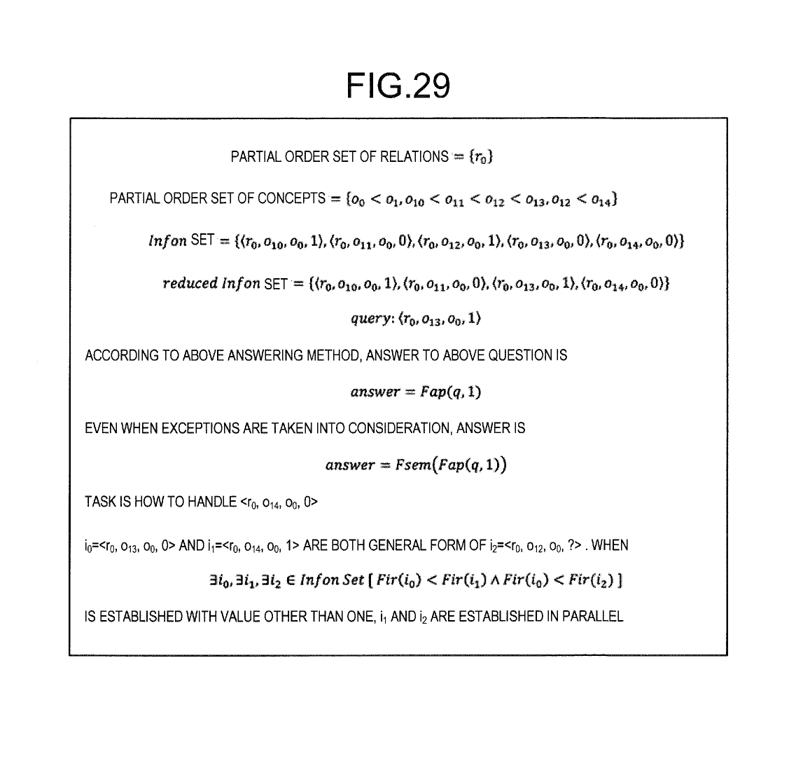

The rules for the inference of the case 3 are as expressed in Eqs. (36) to (40) below. The definition of parallel establishment (the double establishment) is depicted in FIG. 29. FIG. 29 is an explanatory diagram of the definition of the parallel establishment. FIG. 29 depicts the condition under which it can be stated that i₁ and i₂ are established in parallel to each other.

q= [symbol] r,o₁, . . . ,oₙ,? [symbol] (36)

┌q┐₀={x|xε┌q┐ [symbol] P(q)=0} (37)

┌q┐₁={x|xε┌q┐ [symbol] P(q)=1} (38)

(┌q┐₀≠φ [symbol] ┌q┐₁≠φ) [symbol] “┌q┐ is doubly established.” (39)

(┌q┐₀≠φ [symbol] ┌q┐₁≠φ) [symbol] Fap(q·undetermined) because [symbol] ┌q┐₁,┌q┐₀ [symbol] (40)

A case 2 in the classification table 2700 is assumed. When information not induced is present, the case 2 occurs in the case of a person who has a recognition pattern to consider that an extensional definition is sufficient. An answer for the case 2 is, for example, an answer as expressed in Eqs. (41) and (42) to (48).

Answer=└q┘ (41)

The Eq. (41) above is a conservative answer of returning all of known related information.

∀xε└q┘[P(x)=1] [symbol] Answer= [symbol] Fpa(q,1),└q┘ [symbol] (42)

∀xε└q┘[P(x)=0] [symbol] Answer= [symbol] Fpa(q,0),└q┘ [symbol] (43)

└q┘₀={x|xε└q┘ [symbol] P(x)=0} (44)

└q┘₁={x|xε└q┘ [symbol] P(x)=1} (45)

(└q┘₀≠φ [symbol] └q┘₁≠φ) [symbol] [symbol] Fpa(q,undetermined),└q┘ [symbol] ·(conservative inference) (46)

·(└q┘₀≠φ [symbol] └q┘₁≠φ [symbol] └q┘₀·size≦└q┘₁·size) [symbol] [symbol] Fpa(q,1),└q┘₀ [symbol] ·(rough inference) (47)

(└q┘₀≠φ [symbol] └q┘≠φ [symbol] └q┘₀·size>└q┘₁·size) [symbol] [symbol] Fpa(q,0),└q┘₁ [symbol] ·(rough inference) (48)

Eqs. (42) to (48) above are an example of the answer that includes a general answer and a specific example described in parallel. In this case, types of answer include two types and one thereof is referred to as “conservative inference” and the other is referred to as “rough inference”.

A case 1 in the classification table 2700 is assumed. The answering manner for the case 1 is, for example, as expressed in Eq. (49).

Answer=Fpa(q,no information) (49)

In the case 1, no specific example and no general example are present and therefore, no answer can be returned. This situation is that “no consideration is made from such a viewpoint”. Therefore, in the case 1, the answer is “no information is present”.

From the above, the inquiry of the YES-or-NO type is enabled. In the case where information items meaning general cases and exceptions are alternately retained in a multi-stage nested structure, when an exception information item is desired to be correctly propagated, the analysis support apparatus 101 can cope therewith by returning the meaning provided in the definition, based on the set theory, of the Infon for the Infon of the answer. For example, the above state can be coped with by determining in advance a rule of returning the meaning for “1” when the polarity value of the Infon of the answer is a value other than “0” and “1”.

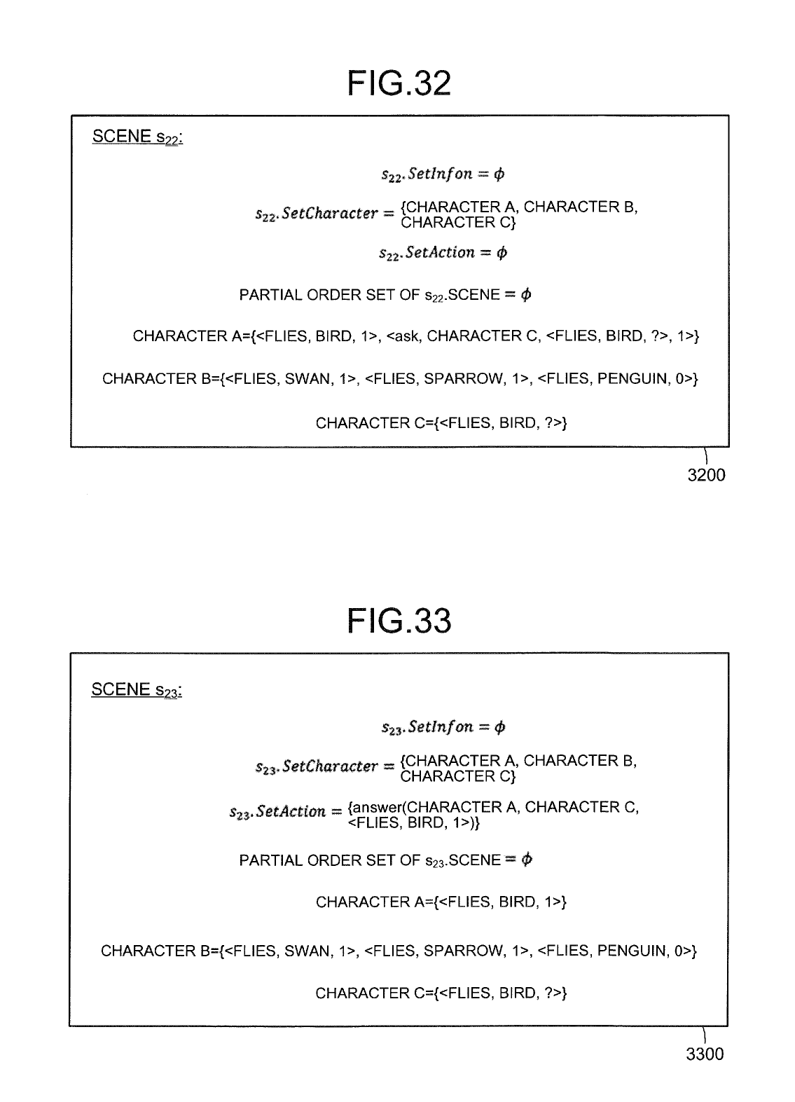

A comics chart including a YES-or-NO query will be described. To clarify the question and the answer, it is assumed that the question represents “X asks me whether<Message>” and is surrounded by “ask” like <ask, X, messageInfon, 1> (see FIG. 32 described later).

It is assumed that the answer represents “X answers that<Message>” and is surrounded by “answer” like <answer, X, messageInfon, 1> (see FIG. 33 described later). For the modeling of a speech in general, “believe” may be added that represents belief.

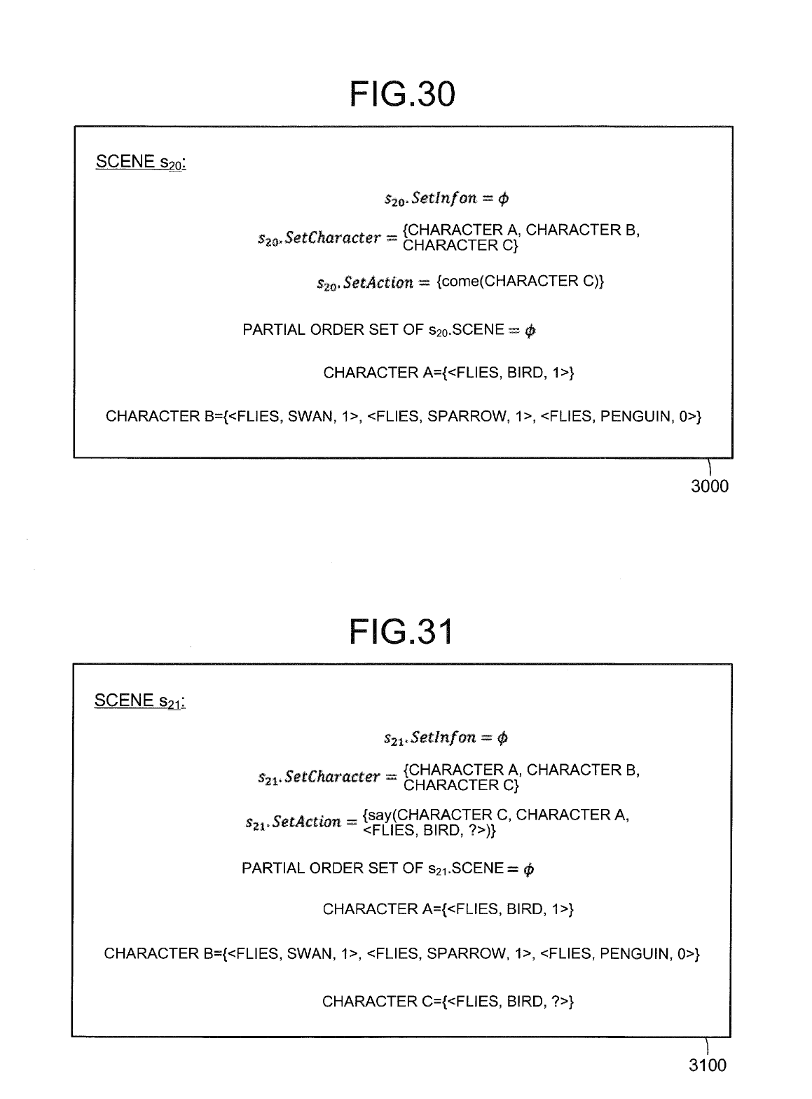

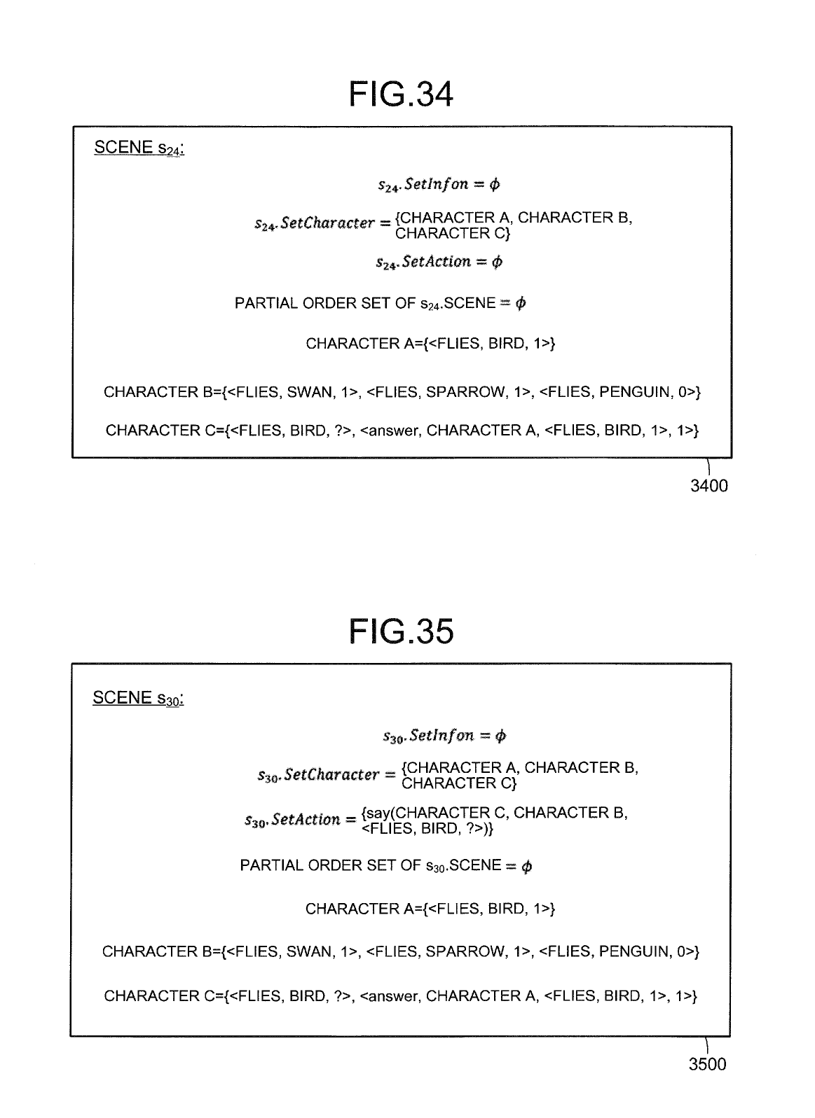

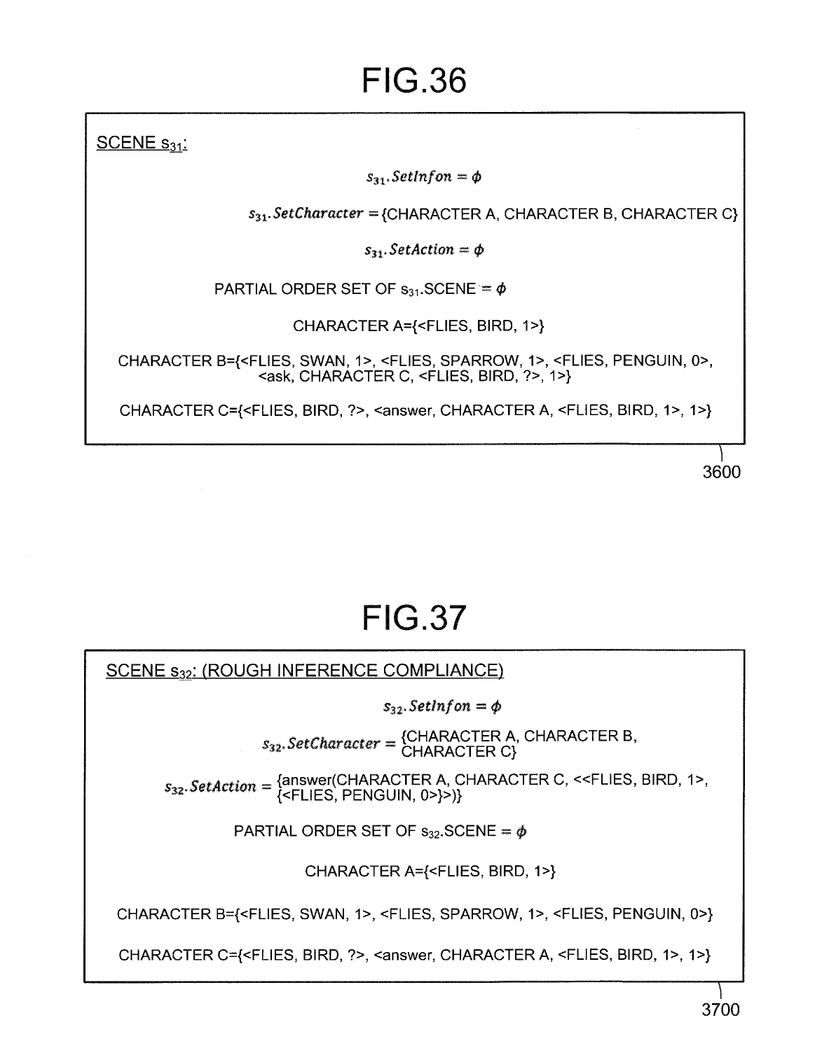

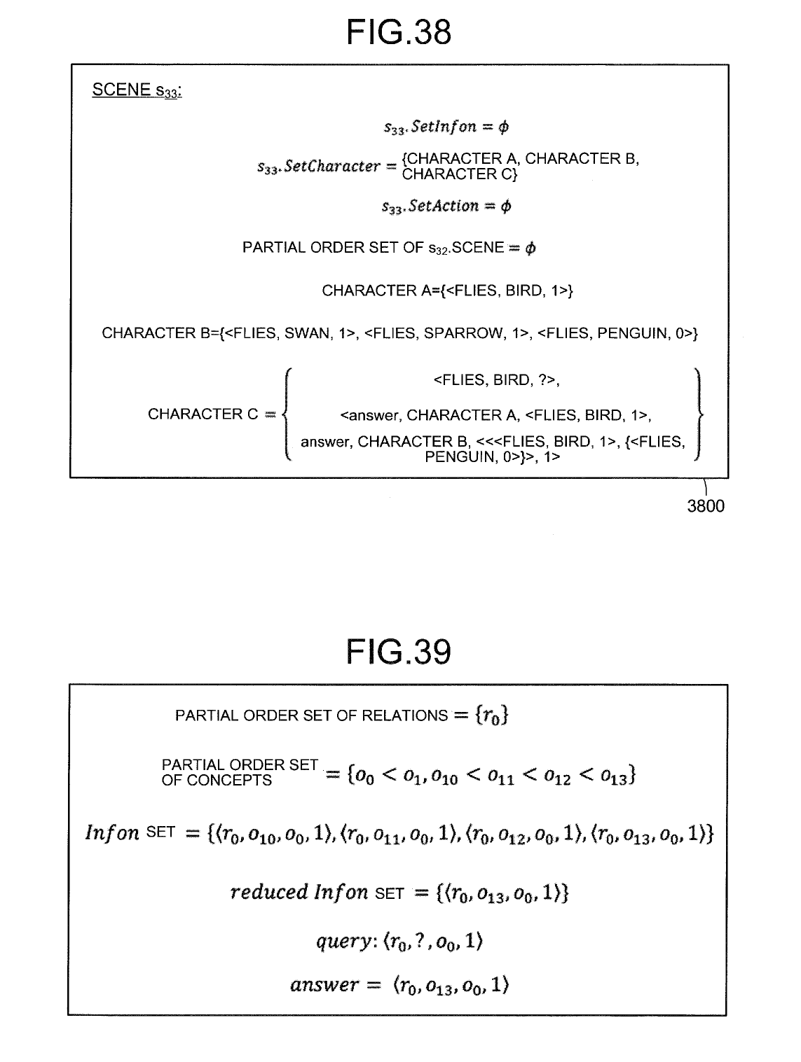

FIGS. 30, 31, 32, 33, 34, 35, 36, 37, and 38 are explanatory diagrams of an example of a comics chart that includes “YES-or-NO Query”. Scenario information items 3000 to 3800 depicted in FIGS. 30 to 38 reproduce a scene where a character C desiring to acquire knowledge asks questions of the characters A and B who are knowledgeable persons.

As above, according to the formalization, the comics chart including inquiries can be configured and an answer to an inquiry can be determined. It can be seen that the processing can be executed even when information is incomplete or discrepancy is present among information items, different from the case of a deductive database or logic programming.

The script of FIGS. 30 to 38 is as follows.

Script={s₋₁→s₀→s₁→s₂,s₋₁→s₃→s₄→s₅→s₆→s₇,s₋₁→s₂₀→s₂₁→s₂₂→s₂₃→s₂₄→s₃₀→s₃₁→s₃₂→s₃₃}

In this case example, the rough inference is executed and therefore, it seems that the character B has the information (Infon) that includes the character A. On the other hand, assuming that the conservative inference is executed, the answer of the character B is <<flies, bird, undetermined>, {<flies, swan, 1>, <flies, sparrow, 1>, <flies, penguin, 0>}>. It can be seen that the characters each return the answer that often is returned by a person who speaks about things that the person extensionally knows.

From the above, according to the formalization, it can be seen that the modeling of the natural communication among the individuals involved is enabled, from which the answers each corresponding to the knowledge of each person are intuitively understood. The stories of the plural scripts can be managed as the scripts and the story of a new script can easily be added.

Addition and deletion of the story of a script can easily be executed and therefore, for example, when plural reviewers are present, whoever creates the script, a scene thereof or the story of the script that is a sequence of scenes can easily be added. Therefore, extraction of problems by role playing can efficiently be executed. The participants can intuitively modify the story of the script based on their intuitive determination.

The story of the script can easily be managed and therefore, such procedure steps for maintaining the findings acquired in the role playing are unnecessary as recording the findings in a notebook and clarifying, documentation, and distribution thereof, by a secretary, etc. Therefore, the work efficiency can be improved.

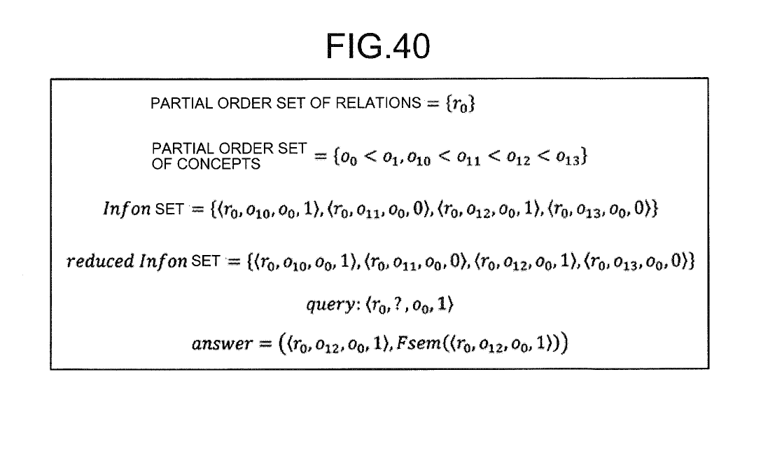

FIGS. 39 and 40 are explanatory diagrams of an example of a “What” query. FIG. 39 depicts an example of a simple What-query. FIG. 40 depicts an example of a complex What-query.

For example, the What-query depicted in FIG. 40 means that “o₁₂ generally has the relation nature depicted in FIG. 40. However, o₁₁ is an exception and can not be established and o₁₀(0₁₁) can be established”. As depicted in FIGS. 39 and 40, an inquiry on an unknown member can be executed using the inheritance relation of the concept.

An analysis support process procedure of the analysis support apparatus 101 according to the embodiment will be described. The case will be described taking an example of the “say action” as an example of an action, where the scenario information for the next scene is produced from the scenario information for the current scene.

The analysis support apparatus 101: reads from the storage device such as the RAM 203, the scenario information for the screen ID that is designated by an operational input by the user; thereby, acquires the scenario information for the current scene; and displays the scenario information for the current scene on the display 208. As a result, the person in charge of the requirements analysis can execute the editing work of the scenario information for the current scene, displayed on the display 208. The analysis support process described as follows is executed when, for example, the analysis support apparatus 101 receives an editing end instruction for the scenario information or a switching instruction for the scene by an operational input by the user.

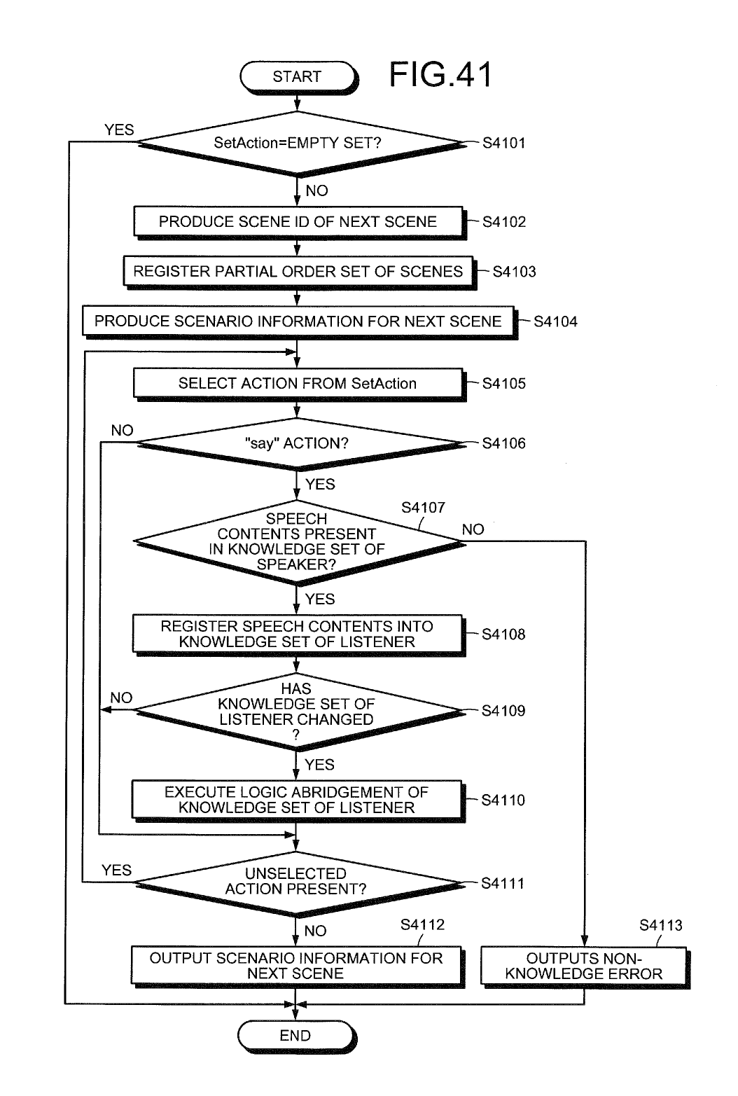

FIG. 41 is a flowchart of an example of the analysis support process procedure of the analysis support apparatus 101. In the flowchart of FIG. 41, the analysis support apparatus 101 first determines whether the SetAction of the scenario information for the current scene is an empty set (step S4101).

If the analysis support apparatus 101 determines that the SetAction is not an empty set (step S4101: NO), the analysis support apparatus 101 produces a scene ID of the next scene (step S4102) and registers the sequential relation between the scene ID of the current scene and the scene ID of the next scene, into the partial order set of the scenes (step S4103).

The analysis support apparatus 101 produces the scenario information for the next scene, which inherits SetCharacter (that corresponds to the “character set”) and the knowledge sets of the characters of the scenario information for the current scene (step S4104), and selects an action from SetAction of the scenario information for the current scene (step S4105).

The analysis support apparatus 101 determines whether the selected action is a “say” action (step S4106). If the analysis support apparatus 101 determines that the selected action is not a “say” action (step S4106: NO), the analysis support apparatus 101 advances to the operation at step S4111.

On the other hand, if the analysis support apparatus 101 determines that the selected action is a “say” action (step S4106: YES), the analysis support apparatus 101 determines whether speech contents are present in the knowledge set of a speaker (step S4107). If the analysis support apparatus 101 determines that speech contents are present in the knowledge set (step S4107: YES), the analysis support apparatus 101 registers the speech contents into the knowledge set of the listener if the speech contents are not yet registered into the knowledge set of the listener (step S4108).

The analysis support apparatus 101 determines whether the knowledge set of the listener has changed (step S4109). If the analysis support apparatus 101 determines that the knowledge set of the listener has not changed (step S4109: NO), the analysis support apparatus 101 advances to the operation at step S4111. On the other hand, if the analysis support apparatus 101 determines that the knowledge set of the listener has changed (step S4109: YES), the analysis support apparatus 101 executes the logic abridgement of the knowledge set of the listener (step S4110).

The analysis support apparatus 101 determines whether an unselected action is present in SetAction in the scenario information for the current scene (step S4111). If the analysis support apparatus 101 determines that an unselected action is present (step S4111: YES), the analysis support apparatus 101 returns to the operation at step S4105 and selects an unselected action from SetAction of the scenario information for the current scene.

On the other hand, if the analysis support apparatus 101 determines that no unselected action is present (step S4111: NO), the analysis support apparatus 101 outputs the scenario information for the next scene (step S4112) and causes the series of process steps according to the flowchart to come to an end. If the analysis support apparatus 101 determines at step S4101 that the SetAction is an empty set (step S4101: YES), the analysis support apparatus 101 causes the process step according to the flowchart to come to an end.

If the analysis support apparatus 101 determines at step S4107 that no speech contents is present in the knowledge set of the speaker (step S4107: NO), the analysis support apparatus 101 outputs a non-knowledge error (step S4113) and causes the series of process steps according to the flowchart to come to an end.

Thereby, the scenario information for the next scene can be produced corresponding to the “say” action that is input into SetAction of the scenario information for the current scene by the operational input by the user. No restriction is provided that a speaker speaks (utters) only about what the speaker knows. If speech corresponding to telling a lie is allowed, the analysis support apparatus 101 may omit the processes at steps S4107 and S4113.

As above, according to the analysis support apparatus 101 according to the embodiment: the scenario information for the next scene can be produced that inherits the character set and the knowledge sets indicated in the scenario information for the current scene; and the speech contents of the speech action input into the action set of the scenario information for the current scene can be registered into the knowledge set of the second character indicated in the scenario information for the next scene. Thereby, the scenario information for the next scene can be produced to which the knowledge spoken by the first character to the second character is added as the knowledge retained by the second character.

According to the analysis support apparatus 101, if the speech contents of the speech action is not included in the knowledge set of the second character indicated in the scenario information for the next scene, the speech contents of the speech action can be registered into the knowledge set of the second character. Thereby, the scenario information for the next scene can be produced to which knowledge is added that is spoken by the first character to the second character and that is new for the second character, as the knowledge retained by the second character.

According to the analysis support apparatus 101, the sequential relation between the current scene and the next scene can be registered into the partial order set of the scenes. Thereby, the transition of the scenes continuously changing due to the communication among the individuals involved can be identified from the partial order set of the scenes and therefore, the information exchanged among the individuals involved can be systematized and clarified.

According to the analysis support apparatus 101, if the speech contents of the speech action is registered into the knowledge set of the second character, the logic abridgement can be executed of the knowledge set of the second character of the scenario information for the next scene. Thereby, the knowledge can be removed that is included in other knowledge items of the knowledge group included in the knowledge sets of the characters and therefore, the knowledge retained by the characters can efficiently be managed.

According to the analysis support apparatus 101, when an entry action is input, the new character who enters by the entry action can be registered into the character set indicated in the scenario information for the next scene. Thereby, the scenario information for the next scene can be produced to which the new character is added who enters by the entry action as the character on the next screen.

According to the analysis support apparatus 101, when the exit action is input, the third character who exits by the exit action can be deleted from the character set of the scenario information for the next scene and the knowledge set of the third character of the scenario information for the next scene can also be deleted. Thereby, the third character who exits by the exit action can be deleted from the characters on the next screen.

As described, according to the analysis support program, the analysis support apparatus, and the analysis support method according to the embodiment, scenario information can be provided that facilitates comprehension of scenes that continuously change due to communication among the individuals involved. As a result, the person in charge of the requirements analysis can systematize and clarify the information exchanged among the individuals involved, facilitating improved work efficiency and improved quality of the requirements analysis.

For example, in the requirements analysis, to acquire a realistic image, clarification of the requirement may be facilitated using role playing. The analysis support apparatus 101 can facilitate the production of the scenario that corresponds to the preliminary work for the role playing; can also facilitate the management of the scenario modification and the scenario branching executed during the role playing; and can display the scenario information as an animation (flip-book animation), in a comics form, and in a chart form. Thereby, the person in charge of the requirements analysis can easily understand intuitively the content that is currently analyzed as to the requirement.

The analysis support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to an aspect of the embodiment, improved work efficiency in analysis can be facilitated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing an analysis support program causing a computer to execute a process comprising:
acquiring first scenario information that formalizes and indicates a character set of characters appearing in a first scene, a knowledge set of knowledge items retained by the characters appearing in the first scene, and an action set of actions taken by the characters appearing in the first scene;
receiving into the action set indicated in the first scenario information, an input of speech contents of a speech action from a first character to a second character who appear in the first scene;
producing second scenario information that inherits the character set and the knowledge set indicated in the first scenario information and, formalizes and indicates a character set of characters appearing in a second scene, a knowledge set of knowledge items retained by the characters appearing in the second scene, and an action set of actions taken by the characters appearing in the second scene; and
registering into the knowledge set of the second character indicated in the produced second scenario information, the speech contents of the speech action for which the input is received.

2. The computer-readable recording medium according to claim 1, the process further comprising
registering into a partial order set of scenes, a sequential relation between the first and the second scenes indicating that the first scene changes to the second scene.

3. The computer-readable recording medium according to claim 1, the process further comprising
executing when the speech contents of the speech action is registered into the knowledge set of the second character, logic abridgement of deleting a second knowledge item implied by a first knowledge item in the knowledge set of the second character, in the second scenario information.

4. The computer-readable recording medium according to claim 3, wherein
the knowledge is expressed as information indicating a relation between an indeclinable word and a declinable word, and
the executing of the logic abridgement includes executing the logic abridgement based on a partial order set of indeclinable words stored in a storing unit.

5. The computer-readable recording medium according to claim 1, wherein
the receiving includes receiving into the action set indicated in the first scenario information, an input of an entry action for an entry of a new character different from the characters appearing in the first scene,
the producing includes producing the second scenario information that inherits the character set and the knowledge set indicated in the first scenario information and, formalizes and indicates the character set of the characters appearing in the second scene, the knowledge set of the knowledge items retained by the characters appearing in the second scene, and the action set of the actions taken by the characters appearing in the second scene, and
the registering includes registering into the character set indicated in the produced second scenario information, the new character entering by the entry action for which the input is received.

6. The computer-readable recording medium according to claim 1, wherein
the receiving includes receiving into the action set indicated in the first scenario information, an input of an exit action for an exit of a third character appearing in the first scene, and
the producing includes producing the second scenario information that inherits the character set and the knowledge set indicated in the first scenario information and, formalizes and indicates the character set of the characters appearing in the second scene, the knowledge set of the knowledge items retained by the characters appearing in the second scene, and the action set of the actions taken by the characters appearing in the second scene;
the process further comprising
deleting from the character set indicated in the produced second scenario information, the third character exiting by the exit action for which the input is received and further deleting a knowledge set of the third character indicated in the second scenario information.

7. An analysis support apparatus comprising
a computer configured to:
acquire first scenario information that formalizes and indicates a character set of characters appearing in a first scene, a knowledge set of knowledge items retained by the characters appearing in the first scene, and an action set of actions taken by the characters appearing in the first scene;
receive into the action set indicated in the first scenario information, an input of speech contents of a speech action from a first character to a second character who appear in the first scene;
produce second scenario information that inherits the character set and the knowledge set indicated in the first scenario information and, formalizes and indicates a character set of characters appearing in a second scene, a knowledge set of knowledge items retained by the characters appearing in the second scene, and an action set of actions taken by the characters appearing in the second scene; and
register into the knowledge set of the second character indicated in the produced second scenario information, the speech contents of the speech action for which the input is received.

8. An analysis support method executed by a computer, the analysis support method comprising:
acquiring first scenario information that formalizes and indicates a character set of characters appearing in a first scene, a knowledge set of knowledge items retained by the characters appearing in the first scene, and an action set of actions taken by the characters appearing in the first scene;
receiving into the action set indicated in the first scenario information, an input of speech contents of a speech action from a first character to a second character who appear in the first scene;
producing second scenario information that inherits the character set and the knowledge set indicated in the first scenario information and, formalizes and indicates a character set of characters appearing in a second scene, a knowledge set of knowledge items retained by the characters appearing in the second scene, and an action set of actions taken by the characters appearing in the second scene; and
registering into the knowledge set of the second character indicated in the produced second scenario information, the speech contents of the speech action for which the input is received.
